(19) United States
(12) Patent Application Publication
(10) Pub. No.: US 2018/0069234 A1
(43) Pub. Date: Mar. 8, 2018

(54) ELECTROACTIVE MATERIALS FOR METAL-ION BATTERIES

(71) Applicant: NEXEON LIMITED, Oxfordshire (GB)

(72) Inventors: Christopher Michael Friend, Oxfordshire (GB); Charles Mason, Oxfordshire (GB); Fritz Wilhelm Wernicke, Oxfordshire (GB); Lisa Murphy, Hertfordshire (GB)

(21) Appl. No.: 15/558,446

(22) PCT Filed: Mar. 16, 2016
(86) PCT No.: PCT/GB16/50714

§ 371 Date: Sep. 14, 2017

(30) Foreign Application Priority Data
Mar. 16, 2015 (GB) 1504367.2

(51) Int. Cl. H01M 4/36; H01M 4/62; H01M 4/583; H01M 4/38

(52) U.S. Cl. CPC H01M 4/364; H01M 4/625; H01M 2004/021; H01M 4/622; H01M 4/386; H01M 4/583

(57) ABSTRACT

A process is provided for preparing a particulate material consisting of a plurality of porous particles comprising an electroactive material selected from silicon, tin, germanium, aluminium or a mixture thereof, wherein the particles are assembled from a plurality of particle fragments comprising the electroactive material wherein the fragments are obtained by the fragmentation of a porous precursor. The fragmentation step may be realized e.g. by wet ball milling and the later assembling step is preferably realized by spray-drying. Also provided are particulate materials obtainable according to the process of the invention, compositions comprising the particulate materials, and electrodes and electrochemical cells comprising the particulate materials. The materials and compositions are especially useful as anode materials in the context of a metal-ion battery such as a lithium-ion battery.

This invention relates in general to electroactive materials for use in electrodes for metal-ion batteries and more specifically to particulate electroactive materials suitable for use as anode active materials in metal-ion batteries. Also provided are processes for the preparation of the particulate electroactive materials of the invention.

Rechargeable metal-ion batteries are widely used in portable electronic devices such as mobile telephones and laptops and there is increasing demand for rechargeable batteries that may be used in electric or hybrid vehicles. Rechargeable metal-ion batteries generally comprise an anode, a cathode, an electrolyte to transport metal ions between the anode and cathode, and an electrically insulating porous separator disposed between the anode and the cathode. The cathode typically comprises a metal current collector provided with a layer of metal ion containing metal oxide based composite, and the anode typically comprises a metal current collector provided with a layer of an electroactive material, defined herein as a material which is capable of inserting and releasing metal ions during the charging and discharging of a battery. For the avoidance of doubt, the terms “cathode” and “anode” are used herein in the sense that the battery is placed across a load, such that the cathode is the positive electrode and the anode is the negative electrode. When a metal-ion battery is charged, metal ions are transported from the metal-ion-containing cathode layer to the anode via the electrolyte and insert into the anode material. The term “battery” is used herein to refer both to a device containing a single anode and a single cathode and to devices containing a plurality of anodes and/or a plurality of cathodes.

There is demand for improvements in the gravimetric and/or volumetric capacities of rechargeable metal-ion batteries. The use of lithium-ion batteries has already provided a substantial improvement when compared to other battery technologies, but there remains scope for further development.

To date, commercial lithium-ion batteries have largely been limited to the use of graphite as an anode active material. When a graphite anode is charged, lithium intercalates between the graphite layers to form a material with the empirical formula LiₓC₆ (wherein x is greater than 0 and less than or equal to 1). Consequently, graphite has a maximum theoretical capacity of 372 mAh/g in a lithium-ion battery, with a practical capacity that is somewhat lower (ca. 340 to 360 mAh/g). Other materials, such as silicon, tin and germanium, are capable of intercalating lithium with a significantly higher capacity than graphite but have yet to find widespread commercial use due to difficulties in maintaining sufficient capacity over numerous charge/discharge cycles.

Silicon in particular is attracting increasing attention as a potential alternative to graphite for the manufacture of rechargeable metal-ion batteries having high gravimetric and volumetric capacities because of its very high capacity for lithium (see, for example, Insertion Electrode Materials for Rechargeable Lithium Batteries, Winter, M. et al. in Adv. Mater. 1998, 10, No. 10). At room temperature, silicon has a theoretical capacity in a lithium-ion battery of about 3,600 mAh/g (based on Li₁₅Si₄). However, its use as an anode material is complicated by large volumetric changes on charging and discharging. Intercalation of lithium into bulk silicon leads to an increase in the volume of the silicon material of up to 400% of its original volume at its maximum capacity. Repeated charge-discharge cycles cause significant mechanical strain in the silicon material, resulting in fracturing and delamination of the silicon anode material. Loss of electrical contact between the anode material and the current collector results in a significant loss of capacity in subsequent charge-discharge cycles.

The use of silicon as an electroactive material in metal-ion batteries is further complicated by the formation of a solid electrolyte interphase (SEI) layer at the anode surface during the first charge-discharge cycle of the battery. SEI layers are formed due to reaction of the electrolyte at the surface of the silicon during the first charging cycle, and it is believed that this reactivity can be attributed to the accumulation of metallic lithium at the silicon surface due to the low diffusion rate of lithium into the bulk of the silicon. The formation of an SEI layer can consume significant amounts of metal ions from the electrolyte during the first charge-discharge cycle (referred to herein as “first cycle loss”, or “FCL”), thus depleting the capacity of the battery in subsequent charge-discharge cycles. In addition, any fracturing or delamination of the silicon during subsequent charge-discharge cycles exposes fresh silicon surfaces which then form SEI layers, further depleting the capacity of the battery.

The use of germanium as an anode active material is known in the art. Germanium has the advantages that it has higher electronic conductivity than silicon (by several orders of magnitude) and a higher lithium diffusion rate (by a factor of ca. 10²), thus making it less susceptible to the formation of SEI layers. However, the use of germanium is also associated with certain disadvantages. Not only is germanium significantly more expensive than silicon, its theoretical maximum gravimetric capacity of ca. 1625 mAh/g in a lithium-ion battery is less than half that of silicon, due to the higher atomic mass of germanium. As with silicon, the insertion and release of metal ions by germanium is associated with large volumetric changes (up to 370% when germanium is lithiated to its maximum capacity). The associated mechanical stress on the germanium material may result in fracturing and delamination of the anode material and a loss of capacity.

A number of solutions have been proposed to overcome the problems associated with the volume change observed when charging silicon-containing anodes. These relate in general to silicon structures which are better able to tolerate volumetric changes than bulk silicon. For example, Ohara et al. (Journal of Power Sources 2004, 136, 303-306) have described the evaporation of silicon onto a nickel foil current collector as a thin film and the use of this structure as the anode of a lithium-ion battery. Although this approach gives good capacity retention, the thin film structures do not give useful amounts of capacity per unit area, and any improvement is eliminated when the film thickness is increased. WO 2007/083155 discloses that improved capacity retention may be obtained through the use of silicon particles having high aspect ratio, i.e. the ratio of the largest dimension to the smallest dimension of the particle. The high aspect ratio, which may be as much as 100 or more, is thought to help to accommodate the large volume changes during charging and discharging without compromising the physical integrity of the particles.

Another approach relates to the use of silicon structures that include void space to provide a buffer zone for the expansion that occurs when lithium is intercalated into silicon. For example, U.S. Pat. No. 6,334,939 and U.S. Pat. No. 6,514,395 disclose silicon based nano-structures for use as anode materials in lithium ion secondary batteries. Such nano-structures include cage-like spherical particles and rods or wires having diameters in the range 1 to 50 nm and lengths in the range 500 nm to 10 μm. WO 2012/175998 discloses particles comprising a plurality of silicon-containing pillars extending from a particle core which may be formed, for example, by chemical etching or by a sputtering process.

Porous silicon particles have also been investigated for use in lithium-ion batteries. The term “porous particle” as used herein shall be understood to refer to particles comprising a network of structural elements, wherein interconnected void spaces or channels are defined between the structural elements. Porous particles may also comprise distinct individual void spaces fully enclosed by structural elements or walls. Porous silicon particles are attractive candidates for use in metal-ion batteries as the cost of preparing these particles is generally less than the cost of manufacturing alternative silicon structures such as silicon fibres, ribbons or pillared particles. The pore structure of the porous particles results in a network of fine silicon elements forming the pore boundaries and pore walls, and these structural elements may be sufficiently fine to withstand the mechanical stress of repeated charge and discharge cycles. In addition, the pores of the porous particles provide void space to accommodate expansion of the electroactive material during intercalation of metal ions, thereby avoiding excessive expansion of electrode layers.

US 2009/0186267 discloses an anode material for a lithium-ion battery, the anode material comprising porous silicon particles dispersed in a conductive matrix. The porous silicon particles have a diameter in the range 1 to 10 μm, pore diameters in the range 1 to 100 nm, a BET surface area in the range 140 to 250 m²/g and crystallite sizes in the range 1 to 20 nm. The porous silicon particles are mixed with a conductive material such as carbon black and a binder such as PVDF to form an electrode material which can be applied to a current collector to provide an electrode.

U.S. Pat. No. 7,479,351 discloses porous silicon-containing particles containing microcrystalline silicon and having a particle diameter in the range of 0.2 to 50 μm. The particles are obtained by alloying silicon with an element X selected from the group consisting of Al, B, P, Ge, Sn, Pb, Ni, Co, Mn, Mo, Cr, V, Cu, Fe, W, Ti, Zn, alkali metals, alkaline earth metals and combinations thereof, followed by removal of the element X by a chemical treatment.

A further approach relates to the use of nanosized silicon particles dispersed in a carbon matrix. For example, Jung et al. (Nano Letters, 2013, 13, 2092-2097) have described silicon-carbon composite particles comprising silicon nanoparticles embedded in a porous carbon matrix. The composite particles are obtained by spray drying an aqueous suspension of silicon nanoparticles (average diameter 70 nm), silica nanoparticles (average diameter 10 nm) and sucrose to form Si/silica/sucrose composite spheres. The sucrose is carbonized at 700° C. followed by chemical etching with HF to remove the silica nanoparticles and thereby form pores in the carbon matrix.

Despite the efforts to date, known porous silicon materials do not meet the performance criteria required for use as electroactive materials for use in commercially viable lithium ion batteries. Foremost among these criteria is the requirement for an electroactive material that provides sufficient capacity retention over the lifetime of the battery. However, it is also desirable that the lifetime performance of the electroactive material be accompanied by other properties which enable the electroactive material to be processed into an electrode layer. In particular, it is desirable that the electroactive material has a carefully controlled particle size distribution so as to enable the formation of electrode layers of uniform thickness and density. Both oversized and undersized particles are detrimental in this regard. Particles which are excessively large disrupt the packing of electrode layers, and particles which are excessively small may form agglomerates in slurries, impeding even distribution of the electroactive material in electrode layers.

The electroactive material must retain its structural integrity during electrode manufacture, in particular during steps such as heat treatment and calendering of electrode active layers as are conventional in the art. In known porous silicon materials, it has been found that as capacity retention is improved, the processability of the porous silicon material deteriorates. This is usually because the substructure of the porous particles is extremely fine and disintegrates.

The use of porous particles as electroactive materials thus presents a number of competing priorities, relating in particular to the ability of the porous particles to withstand the mechanical stress of repeated charge and discharge cycles, the dimensions of the particles, and the processability of the particles.

The performance requirements of electroactive materials are particularly exacting when the electroactive materials are used in “hybrid” electrodes, in which electroactive materials having high capacity, such as silicon, are used to supplement the capacity of graphite anodes. Hybrid electrodes are of particular interest to manufacturers focusing on incremental improvements to existing metal-ion battery technology rather than a wholesale transition from graphite anodes to silicon anodes.

For a hybrid electrode to be commercially viable, any additional electroactive material must be provided in a form which is compatible with the graphite particulate forms conventionally used in metal-ion batteries. For example, it must be possible to disperse the additional electroactive material in a matrix of graphite particles. The particles of the additional electroactive material must also have sufficient structural integrity to withstand compounding with graphite particles and subsequent formation of an electrode layer, for example via steps such as compressing, drying and calendering. Differences in the metallation properties of graphite and other electroactive materials must also be taken into account when developing hybrid anodes. In the lithiation of a graphite-containing hybrid anode in which graphite constitutes at least 50 wt % of the electroactive material, a silicon-containing electroactive material needs to be lithiated to its maximum capacity to gain the capacity benefit from all the electroactive material. Whereas in a non-hybrid silicon electrode, the silicon material would generally be limited to ca. 25 to 60% of its maximum gravimetric capacity during charge and discharge so as to avoid placing excessive mechanical stresses on the silicon material and a resultant reduction in the overall volumetric capacity retention of the cell, this option is not available in hybrid electrodes. Consequently, the electroactive material must be able to withstand very high levels of mechanical stress through repeated charge and discharge cycles.

Accordingly, there remains a need in the art to identify electroactive materials in which high gravimetric and volumetric capacity is obtained alongside commercially acceptable capacity retention of the electroactive material over multiple charge-discharge cycles. Preferably, the capacity retention over the lifetime of the electroactive material should not compromise the handling properties of the electroactive material. Furthermore, it would be desirable to identify electroactive materials having lifetime performance and handling properties meeting the criteria for hybrid anodes. Key to these objectives is the identification of methodology for the preparation of electroactive materials with control of particle morphology, including particle size, pore size distributions and overall porosity.

In a first aspect, the present invention provides a process for preparing a particulate material consisting of a plurality of porous particles comprising at least 30% by weight of an electroactive material selected from silicon, tin, germanium, aluminium or a mixture thereof, the process comprising assembling the porous particles from a plurality of fragments comprising the electroactive material, wherein the fragments are obtainable via the fragmentation of a porous precursor comprising the electroactive material.

It has been found that the process of the invention provides particular advantages compared to the prior art. Using known methodology, it is extremely difficult to prepare porous particles in which the porosity and pore size distribution is optimised for use as an anode active material, while at the same time controlling the particle size and particle size distribution within the limits imposed by electrode design constraints. However, the present inventors have now found that by reassembling particles from a plurality of fragments obtained by the fragmentation of a porous precursor, the porosity and pore size distribution of the porous particles and the particle size and particle size distribution of the porous particles may be controlled independently from one another. The porosity and pore size distribution of the porous particles are determined by the size and shape of the fragments, which is in turn determined by the pore structure of the porous precursor. The external dimensions of the porous precursor are immaterial since only the pore structure of the porous precursor is reflected in the morphology of the fragments. Accordingly, methodologies for obtaining suitable pore structures in the porous precursor are not constrained by the need to control simultaneously the external dimensions of the porous precursor. Furthermore, by assembling porous particles from individual fragments, far greater control over particle size and particle size distribution is obtained than is possible in known processes for fabricating porous particles directly.

The pore structure of the particulate material of the invention is a function of the size, shape and surface morphology of adjacent fragments in each particle. The random juxtaposition of a plurality of irregularly shaped fragments results in particles having a unique and irregular pore structure. The porosity of the particles provides void space to accommodate expansion of the electroactive material during intercalation of metal ions, thereby avoiding excessive expansion of the electrode layer, whilst minimising or avoiding the presence of excessively-sized pore spaces which are not fully utilised in accommodating expansion of the electroactive material and thereby reduce the overall volumetric charge capacity of the particulate material. Furthermore, by forming the particulate material from a plurality of smaller fragments and incorporating additional conductive components, the electronic conductivity of the particulate material can be increased and sustained during use. Thus, the particulate material of the invention provides reversible capacity over multiple charge-discharge cycles at a level which is commercially acceptable.

The term “porous precursor” as used herein shall be understood to refer to a body comprising an electroactive material as defined herein, wherein the body comprises a plurality of pores, voids or channels within its structure.

The term “fragment” as used herein shall be understood to refer to fragments obtainable from the fragmentation of a porous precursor comprising an electroactive material as defined herein, such that at least a portion of the fragments retain shape features corresponding to the porous structure of the porous precursor. Thus, at least a portion of the fragments will have a shape and surface morphology which corresponds at least in part to the shape and surface morphology of the material originally defining the pore boundaries of the porous precursor. The shape and surface morphology of the fragments will also correspond in part to the fracture surfaces formed during fragmentation of the porous precursor. The fragments may thus include an array of shape features, such as ridges, bumps, spikes, indentations, and branches derived from the pore structure of the porous precursor. It will be understood that the fragments and the porous precursor from which they are formed will have the same elemental composition.

The fragments preferably comprise at least 40 wt %, preferably at least 50 wt %, more preferably at least 60 wt %, more preferably at least 70 wt %, more preferably at least 75 wt %, more preferably at least 80 wt %, and most preferably at least 85 wt % of the electroactive material. For example, the fragments may comprise at least 90 wt %, at least 95 wt %, at least 98 wt %, or at least 99 wt % of the electroactive material.

Preferred electroactive materials are silicon, germanium and tin. Thus, the fragments preferably comprise at least 40 wt %, preferably at least 50 wt %, more preferably at least 60 wt %, more preferably at least 70 wt %, more preferably at least 75 wt %, more preferably at least 80 wt %, and most preferably at least 85 wt % of one or more of silicon, germanium and tin. For example, the fragments may comprise at least 90 wt %, at least 95 wt %, at least 98 wt %, or at least 99 wt % of one or more of silicon, germanium and tin.

A particularly preferred component of the electroactive material is silicon. Thus, the fragments may comprise at least 40 wt %, preferably at least 50 wt %, more preferably at least 60 wt %, more preferably at least 70 wt %, more preferably at least 75 wt %, more preferably at least 80 wt %, and most preferably at least 85 wt % of silicon. For example, the fragments may comprise at least 90 wt %, at least 95 wt %, at least 98 wt %, or at least 99 wt % of silicon.

In some embodiments, the fragments may comprise silicon and a minor amount of aluminium and/or germanium. For instance, the fragments may comprise at least 60 wt % silicon and up to 40 wt % aluminium and/or germanium, more preferably at least 70 wt % silicon and up to 30 wt % aluminium and/or germanium, more preferably at least 75 wt % silicon and up to 25 wt % aluminium and/or germanium, more preferably at least 80 wt % silicon and up to 20 wt % aluminium and/or germanium, more preferably at least 85 wt % silicon and up to 15 wt % aluminium and/or germanium, more preferably at least 90 wt % silicon and up to 10 wt % aluminium and/or germanium, and most preferably at least 95 wt % silicon and up to 5 wt % aluminium and/or germanium. Optionally, the fragments may comprise at least 0.01 wt % aluminium and/or germanium, at least 0.1 wt % aluminium and/or germanium, at least 0.5 wt % aluminium and/or germanium, at least 1 wt % aluminium and/or germanium, at least 2 wt % aluminium and/or germanium, or at least 3 wt % aluminium and/or germanium.

The electroactive material preferably comprises at least 90 wt %, more preferably at least 95 wt %, more preferably at least 98 wt %, more preferably at least 99 wt % of one or more of silicon, germanium and tin. For example, the electroactive material may consist essentially of one or more of silicon, germanium and tin. More preferably, the electroactive material comprises at least 90 wt %, more preferably at least 95 wt %, more preferably at least 98 wt %, more preferably at least 99 wt % silicon. For example, the electroactive material may consist essentially of silicon.

The use of a mixture of silicon and germanium as the electroactive material may be advantageous in some embodiments since it allows the gravimetric and volumetric capacity benefits of silicon to be realised alongside the increased conductivity and metal ion diffusion provided by germanium. In this way, the disadvantageous formation of SEI layers at the surface of silicon is reduced without the cost or loss of capacity due to the use of germanium becoming prohibitive. Aluminium may be present in the fragments as a residue from the process used to produce the porous precursor material. As aluminium is itself capable of inserting and releasing lithium ions, its presence as a part of the electroactive material is not detrimental and may indeed be preferred since complete removal of aluminium from the porous precursor may be challenging and/or costly.

Silicon, tin, germanium and aluminium may be present in combination with their oxides, for example due to the presence of a native oxide layer. As used herein, references to silicon and germanium shall be understood to include the oxides of silicon and germanium. Preferably, the oxides are present in an amount of no more than 30 wt %, more preferably no more than 25 wt %, more preferably no more than 20 wt %, more preferably no more than 15 wt %, more preferably no more than 10 wt %, more preferably no more than 5 wt %, for example no more than 4 wt %, no more than 3 wt %, no more than 2 wt % or no more than 1 wt %, based on the total amount of silicon, tin, germanium, aluminium and the oxides thereof.

The fragments may optionally comprise a minor amount of one or more additional elements other than silicon, tin, germanium and aluminium. For instance, the fragments may comprise a minor amount of one or more additional elements selected from Sb, Cu, Mg, Zn, Mn, Cr, Co, Mo, Ni, Be, Zr, Fe, Na, Sr, P, Ru, Ag, Au and oxides thereof. Preferably the one or more additional elements, if present, are selected from one or more of Ni, Ag, and Cu. The one or more additional elements are preferably present in a total amount of no more than 40 wt %, more preferably no more than 30 wt %, more preferably no more than 25 wt %, more preferably no more than 20 wt %, more preferably no more than 15 wt %, more preferably no more than 10 wt %, and most preferably no more than 5 wt %, based on the total weight of the fragments. Optionally, the one or more additional elements may be present in a total amount of at least 0.01 wt %, at least 0.05 wt %, at least 0.1 wt %, at least 0.2 wt %, at least 0.5 wt %, at least 1 wt %, at least 2 wt %, or at least 3 wt %, based on the total weight of the fragments.

The fragments preferably comprise amorphous or nanocrystalline electroactive material having a crystallite size of less than 100 nm, preferably less than 60 nm. The fragments may comprise a mixture of amorphous and nanocrystalline electroactive material. The crystallite size may be determined by X-ray diffraction spectrometry analysis using an X-ray wavelength of 1.5456 nm. The crystallite size is calculated using the Scherrer equation from a 20 XRD scan, where the crystallite size d=K·λ/(B·Cos θ_{B}), the shape constant K is taken to be 0.94, the wavelength λ is 1.5456 nm, θ_{B} is the Bragg angle associated with the 220 silicon peak, and B is the full width half maximum (FWHM) of that peak. Suitably the crystallite size is at least 10 nm.

The fragments preferably have a D₅₀ particle diameter of at least 300 nm, more preferably at least 500 nm. For example, the D₅₀ particle diameter of the fragments may be at least 800 nm, or at least 1 μm. In some embodiments, i.e. when the process of the invention is used to product large particles, the D₅₀ particle diameter of the fragments may be at least 2 μm, at least 3 μm, or at least 4 μm. Preferably, the D₅₀ particle diameter of the fragments is no more than 10 μm, more preferably no more than 8 μm, more preferably no more than 6 μm, more preferably no more than 4 μm, more preferably no more than 2 μm, and most preferably no more than 1.5 μm.

The D₁₀ particle diameter of the fragments is preferably at least 100 nm, more preferably at least 200 nm, more preferably at least 300 nm, for example at least 400 nm, at least 500 nm, or at least 600 nm.

The D₉₀ particle diameter of the fragments is preferably no more than 15 μm, more preferably no more than 10 μm, more preferably no more than 8 μm, more preferably no more than 6 μm, and most preferably no more than 4 μm.

Preferably, the fragments have a narrow fragment size distribution span. For instance, the fragment size distribution span (defined as (D₉₀-D₁₀)/D₅₀) is preferably 5 or less, more preferably 4 or less, more preferably 3 or less, more preferably 2 or less and most preferably 1.5 or less.

For the avoidance of doubt, the term “particle diameter” as used herein refers to the equivalent spherical diameter (esd), i.e. the diameter of a sphere having the same volume as a given particle, wherein the particle volume is understood to include the volume of the intra-particle pores. The terms “D₅₀” and “D₅₀ particle diameter” as used herein refer to the volume-based median particle diameter, i.e. the diameter below which 50% by volume of the particle population is found. The terms “D₁₀” and “D₁₀ particle diameter” as used herein refer to the 10th percentile volume-based median particle diameter, i.e. the diameter below which 10% by volume of the particle population is found. The terms “D₉₀” and “D₉₀ particle diameter” as used herein refer to the 90th percentile volume-based median particle diameter, i.e. the diameter below which 90% by volume of the particle population is found. The terms “D₉₉” and “D₉₉ particle diameter” as used herein refer to the 99th percentile volume-based median particle diameter, i.e. the diameter below which 99% by volume of the particle population is found.

Particle diameters and particle size distributions as reported herein can be determined by routine laser diffraction techniques. Laser diffraction relies on the principle that a particle will scatter light at an angle that varies depending on the size the particle and a collection of particles will produce a pattern of scattered light defined by intensity and angle that can be correlated to a particle size distribution. A number of laser diffraction instruments are commercially available for the rapid and reliable determination of particle size distributions. Unless stated otherwise, particle size distribution measurements as specified or reported herein are as measured by the conventional Malvern Mastersizer 2000 particle size analyzer from Malvern Instruments. The Malvern Mastersizer 2000 particle size analyzer operates by projecting a helium-neon gas laser beam through a transparent cell containing the particles of interest suspended in an aqueous solution. Light rays which strike the particles are scattered through angles which are inversely proportional to the particle size and a photodetector array measures the intensity of light at several predetermined angles and the measured intensities at different angles are processed by a computer using standard theoretical principles to determine the particle size distribution. Laser diffraction values as reported herein are obtained using a wet dispersion of the particles in distilled water. The particle refractive index is taken to be 3.50 and the dispersant index is taken to be 1.330. Particle size distributions are calculated using the Mie scattering model.

The fragments may be characterised by the presence of a plurality of elongate structural elements that are integrally connected and have an average minimum dimension (for example the average width or thickness of the structural elements) in the range of from 10 nm to 500 nm. The average minimum dimension is preferably no more than 400 nm, more preferably no more than 300 nm and most preferably no more than 200 nm, for example no more than 100 nm. The average minimum dimension of the structural elements may optionally be at least 15 nm, more preferably at least 20 nm, more preferably at least 25 nm, for example at least 30 nm. Adjacent structural elements may have spaces defined between themselves with a distance at least equal to the minimum dimension of the structural elements. The elongate structural elements of the fragments may include structural elements having an aspect ratio of at least 2:1, preferably at least 3:1, more preferably at least 4:1 and most preferably at least 5:1.

The fragments are obtainable via the fragmentation of a porous precursor having the same elemental composition as the fragments and comprising a random or ordered network of structural elements defining a plurality or discrete or interconnected void spaces or channels. In particular, the term “porous precursor” shall be understood to include a porous body comprising a random network of irregular elongate, linear or branched structural elements having a structure which may be described as acicular, dendritic, or coral-like. Suitable porous precursors may be characterised for example by the presence of elongate structural elements having an average minimum dimension in the range of from 10 nm to 500 nm, and preferably an irregular morphology. The average minimum dimension of the structural elements is preferably no more than 400 nm, more preferably no more than 300 nm and most preferably no more than 200 nm, for example no more than 100 nm. The average minimum dimension of the structural elements is preferably at least 15 nm, more preferably at least 20 nm, more preferably at least 25 nm, and most preferably at least 30 nm. The elongate structural elements of the porous precursor may include structural elements having an aspect ratio of at least 2:1, preferably at least 3:1, more preferably at least 4:1 and most preferably at least 5:1.

Suitable porous precursors may be in the form of porous particles having a D₅₀ particle diameter in the range of from 5 μm to 5 mm. Preferably, the D₅₀ particle diameter of the porous precursor particles is at least 10 μm, at least 20 μm or at least 50 μm.

The internal porosity of the porous precursor is defined herein as the ratio of the volume of internal pores to the volume of the porous precursor, excluding any void space between discrete porous precursor bodies. In the case of a particulate porous precursor, the term “internal porosity” is equivalent to the term “intra-particle porosity” as defined herein.

The fragments may suitably be obtained from a porous precursor having internal porosity of at least 40%, preferably at least 50%, and most preferably at least 60%. The internal porosity of the porous precursor is preferably no more than 87%, more preferably no more than 86%, more preferably no more than 85%, for example no more than 80%, or no more than 75%.

Where the porous precursor is prepared by removal of an unwanted component from a starting material, e.g. by leaching of an alloy as discussed in further detail below, the internal porosity can suitably be estimated by determining the elemental composition of the particles before and after leaching and calculating the volume of material that is removed. More preferably the porosity of the porous precursor and of the porous particles obtainable according to the process of the invention may be measured by mercury porosimetry.

Mercury porosimetry is a technique that characterises the porosity of a material by applying varying levels of pressure to a sample of the material immersed in mercury. The pressure required to intrude mercury into the pores of the sample is inversely proportional to the size of the pores. More specifically, mercury porosimetry is based on the capillary law governing liquid penetration into small pores. This law, in the case of a non-wetting liquid such as mercury, is expressed by the Washburn equation:

D=(1/P)·4γ·cos φ

wherein D is pore diameter, P is the applied pressure, γ is the surface tension, and φ is the contact angle between the liquid and the sample. The volume of mercury penetrating the pores of the sample is measured directly as a function of the applied pressure. As pressure increases during an analysis, pore size is calculated for each pressure point and the corresponding volume of mercury required to fill these pores is measured. These measurements, taken over a range of pressures, give the pore volume versus pore diameter distribution for the sample material. The Washburn equation assumes that all pores are cylindrical. While true cylindrical pores are rarely encountered in real materials, this assumption provides sufficiently useful representation of the pore structure for most materials. For the avoidance of doubt, references herein to pore diameter shall be understood as referring to the equivalent cylindrical dimensions as determined by mercury porosimetry. Values obtained by mercury porosimetry as reported herein are obtained in accordance with ASTM UOP574-11, with the surface tension γ taken to be 480 mN/m and the contact angle φ taken to be 140° for mercury at room temperature. The density of mercury is taken to be 13.5462 g/cm³ at room temperature.

The total pore volume of a particulate sample is the sum of intra-particle and inter-particle pores. This gives rise to an at least bimodal pore diameter distribution curve in a mercury porosimetry analysis, comprising a set of one or more peaks at lower pore sizes relating to the intra-particle pore diameter distribution and set of one or more peaks at larger pore sizes relating to the inter-particle pore diameter distribution. From the pore diameter distribution curve, the lowest point between the two sets of peaks indicates the diameter at which the intra-particle and inter-particle pore volumes can be separated. The pore volume at diameters greater than this is assumed to be the pore volume associated with inter-particle pores. The total pore volume minus the inter-particle pore volume gives the intra-particle pore volume from which the intra-particle porosity can be calculated.

A number of high precision mercury porosimetry instruments are commercially available, such as the AutoPore IV series of automated mercury porosimeters available from Micromeritics Instrument Corporation, USA. For a complete review of mercury porosimetry reference may be made to P.A. Webb and C. Orr in “Analytical Methods in Fine Particle Technology, 1997, Micromeritics Instrument Corporation, ISBN 0-9656783-0.

It will be appreciated that mercury porosimetry and other intrusion techniques are effective only to determine the pore volume of pores that are accessible to mercury (or another fluid) from the exterior of the porous particles to be measured. As noted above, substantially all of the pore volume of the particles of the invention is accessible from the exterior of the particles, and thus porosity measurements by mercury porosimetry will generally be equivalent to the entire pore volume of the particles. Nonetheless, for the avoidance of doubt, intra-particle porosity values and internal porosity values as specified or reported herein shall be understood as referring to the volume of open pores, i.e. pores that are accessible to a fluid from the exterior of the particles of the invention and/or the porous precursor. Fully enclosed pores which cannot be identified by mercury porosimetry shall not be taken into account herein when specifying or reporting intra-particle porosity or internal porosity.

Preferred porous precursors are preferably further characterised by the way that the porosity is distributed throughout the porous precursor. Preferably, the porosity is associated with a pore diameter distribution which ensures that the electroactive material structures in the porous precursor are sufficiently robust to retain structural features from the porous precursor following fragmentation and maintain their structural integrity during assembly of the porous particles of the invention and subsequent processing of the particulate material into electrode layers. However, the electroactive material structures in the porous precursor should not be so large that the porous particle fragments undergo unacceptable stress during charging and discharging when the particulate material of the invention is used as an electroactive material.

Preferred porous precursors thus have a pore diameter distribution having a peak corresponding to the internal or intra-particles pores in the range of from 50 nm to less than 500 nm as determined by mercury porosimetry. Preferably the pore diameter distribution has at least one peak corresponding to the internal or intra-particles pores at a pore size less than 460 nm, more preferably less than 420 nm, more preferably less than 400 nm, more preferably less than 380 nm, more preferably less than 360 nm, and most preferably less than 350 nm, as determined by mercury porosimetry. Preferably, the pore diameter distribution has at least one peak corresponding to the internal or intra-particles pores at a pore size of more than 60 nm, more preferably more than 80 nm, more preferably more than 100 nm, as determined by mercury porosimetry.

Fragmentation of the porous precursor to obtain the fragments may be carried out in principle by any known process for pulverising solids to form fine powders. Suitable processes include wet ball milling, jet milling, high-shear stirring and ultrasound. Ultrasonic fragmentation of the porous precursor may suitably be carried out at around 20 to 30 KHz for a period of from 1 to 20 minutes using a suspension of the porous precursor in water or an organic solvent. Wet ball milling may suitably be carried out using a planetary ball milling apparatus and a slurry of the porous precursor containing from 5 to 20 wt % solids in water or an organic solvent. Suitably, 100 to 300 g of zirconia beads of diameter 1 mm are used per 10 g of the porous precursor and milling is carried out for a period of from 5 minutes to 1 hour, e.g. 10 to 45 minutes, or 15 to 30 minutes. The milling may be done in an inert atmosphere.

The fragmentation of the porous precursor is controlled such that at least a portion of the porous particle fragments have the aforementioned irregular surface morphology derived from the pore structure of the porous precursor. It will be understood that if the fragments formed are extremely fine then fewer shape features derived from the pore structure of the porous precursor will be retained in the fragments and the porosity of the particulate material formed by the process of the invention will be low. The porous precursor should therefore not be over-milled. Overmilling may manifest in a bimodal fragment size distribution, with a significant peak in the fines region, e.g. less than 100 nm and particularly less than 50 nm.

The fragments may optionally be classified according to size prior to fabrication of the particulate material of the invention, for instance by centrifugation or by sieving.

It is not excluded that the fragments may include some intact particles from the porous precursor, provided that such intact particles fall within the size specifications required of the fragments. Typically, such intact particles, if present, will constitute less than 20 wt % of the fragments, for example less than 10 wt % or less than 5 wt % of the fragments. The term “fragments” as used herein shall be understood to include the entirety of an electroactive material obtained from the fragmentation of the porous precursor, inclusive of any intact particles.

The fragments may comprise one or more pores, wherein said pores are retained from the pore structure of the porous precursor, or the fragments may be substantially non-porous.

The porous precursor may be obtained in principle by any known process for preparing porous materials comprising the electroactive materials defined herein. Suitable processes include leaching alloys comprising silicon and/or germanium, stain etching of silicon or germanium, foaming of silicon, germanium, tin or aluminium, and reduction of porous or non-porous silicon oxides including silica and silicon monoxide, e.g. using magnesiothermic reduction.

A preferred process for obtaining a porous precursor comprising silicon and/or germanium and optionally aluminium comprises leaching an alloy comprising silicon and/or germanium structures dispersed in a metal matrix. This process relies on the observation that a network of high aspect ratio silicon and/or germanium nanostructures is precipitated within an alloy matrix when certain alloys containing these elements are cooled from the molten state. Suitably, the alloys comprise matrix metals in which the solubility of silicon and/or germanium is low and/or in which the formation of intermetallics on cooling is negligible or non-existent. Leaching of the metals constituting the metal matrix by a suitable liquid leachant exposes the network of silicon and/or germanium structures.

Preferably the alloy is obtained by cooling a molten alloy comprising: (i) from 11 to 30 wt % of an electroactive material component selected from silicon, germanium and mixtures thereof, to form an alloy comprising discrete electroactive material containing structures dispersed in the matrix metal component. At least a portion of the matrix metal component is removed by leaching to expose a network of electroactive material containing structures defining a plurality of discrete or interconnected void spaces or channels. Preferably, porous precursors in the form of leached alloys comprise no more than 40% by weight of residual matrix metal component.

A preferred component of the electroactive material is silicon or a combination of silicon and germanium, wherein the combination comprises at least 90 wt % silicon, more preferably at least 95 wt % silicon, more preferably at least 98 wt % silicon, and most preferably at least 99 wt % silicon.

The alloy preferably comprises at least 11.2 wt %, more preferably at least 11.5 wt %, more preferably at least 11.8 wt %, more preferably at least 12 wt %, and most preferably at least 12.2 wt % of the electroactive material component. For example, the alloy may comprise at least 12.2 wt %, at least 12.4 wt %, at least 12.6 wt %, at least 12.8 wt %, or at least 13 wt % of the electroactive material component. Optionally, the alloy may comprise at least 14 wt %, at least 16 wt %, at least 18 wt % or at least 20 wt % of the electroactive material component. Preferably, the alloy comprises less than 27 wt %, optionally less than 26 wt %, less than 24 wt %, less than 22 wt %, less than 20 wt % or less than 18 wt % of the electroactive material component. For example, the alloy may comprise from 11.2 to 18 wt % or, from 12 to 18 wt %, from 13 to 20 wt %, from 14 to 22 wt %, from 18 to 27 wt % or from 20 to 26 wt % of the electroactive material component. The amount of electroactive material in the alloy particles is of course dictated by the desired structure of the porous precursor, including the desired porosity and pore size, and the dimensions of the structural elements.

The matrix metal component is suitably selected from Al, Sb, Cu, Mg, Zn, Mn, Cr, Co, Mo, Ni, Be, Zr, Fe, Sn, Ru, Ag, Au and combinations thereof. Preferably, the matrix metal component comprises one or more of Al, Ni, Ag or Cu. More preferably, the matrix metal component comprises at least 50 wt %, more preferably at least 60 wt %, more preferably at least 70 wt %, more preferably at least 80 wt %, more preferably at least 90 wt % and most preferably at least 95 wt % of one or more of Al, Ni, Ag or Cu.

A preferred matrix metal component is aluminium. Thus, the matrix metal component may be aluminium, or a combination of aluminium with one or more additional metals or rare earths, for example one or more of Sb, Cu, Mg, Zn, Mn, Cr, Co, Mo, Ni, Be, Zr, Fe, Na, Sr, P, Ru, Ag and Au, wherein the combination comprises at least 50 wt %, more preferably at least 60 wt %, more preferably at least 70 wt %, more preferably at least 80 wt %, more preferably at least 90 wt %, more preferably at least 95 wt % aluminium. More preferably, the matrix metal component is selected from aluminium or a combination of aluminium with copper and/or silver and/or nickel, wherein the combination comprises at least 50 wt %, more preferably at least 60 wt %, more preferably at least 70 wt %, more preferably at least 80 wt %, more preferably at least 90 wt % and most preferably at least 95 wt % of aluminium.

Most preferably, the electroactive material is silicon and the matrix metal component is aluminium. Silicon-aluminium alloys are well-known in the field of metallurgy and have a range of useful properties, including excellent wear-resistance, cast-ability, weld-ability and low shrinkage. They are widely used in industry wherever these properties are desired, for instance as car engine blocks and cylinder heads. It has now been found that silicon-aluminium alloys are particularly useful for the preparation of the particulate material of the invention.

The shape and distribution of the discrete electroactive material structures within the alloy is a function of both the composition of the alloy and the process by which the alloy is made. In particular, the size and shape of the electroactive material structures may be influenced by controlling the rate of cooling of the alloy from the melt and the presence of modifiers (chemical additives to the melt). In general, faster cooling will lead to the formation of smaller, more evenly distributed silicon structures. A suitable cooling rate may be at least 1×10³ K/s, or at least 1×10⁴ K/s, or at least 1×10⁵ K/s, or at least 5×10⁵K/s, or at least 1×10⁶K/s, or at least 1×10⁷ K/s.

Suitably the alloy may be in the form of particles, sheets, ribbons or flakes. Processes for obtaining alloy particles with a cooling rate of at least 10³ K/s include gas atomisation, water atomisation, melt-spinning, splat cooling and plasma phase atomisation and extrusion. Preferred processes include gas atomisation, water atomisation and melt-spinning. Particularly preferred are gas atomisation and melt-spinning. The alloy particles may suitably have D₅₀ particle diameter in the range of from 500 nm to 500 μm, preferably from 5 μm to 100 μm.

Leaching of the matrix metal component may be carried out, for instance using sodium hydroxide, hydrochloric acid, ferric chloride, or a mixed acid leachant such as Keller's reagent (a mixture of nitric acid, hydrochloric acid, and hydrofluoric acid). Alternatively, the matrix metal component may be leached electrochemically using salt electrolytes, e.g. copper sulfate or sodium chloride. Preferably, the matrix metal component is leached using hydrochloric acid. Leaching is carried out until the desired porosity of the porous particles is achieved. For example, acid leaching using 6M aqueous HCl at room temperature for a period of from 10 to 60 minutes is sufficient to leach substantially all of the leachable aluminium from the silicon-aluminium alloys described herein (noting that a minor amount of the matrix metal may not be leached).

Porous precursors obtained by a leaching process as described herein may optionally comprise residual matrix metal component as defined above in an amount of no more than 40 wt %, more preferably no more than 30 wt %, more preferably no more than 25 wt %, more preferably no more than 20 wt %, more preferably no more than 15 wt %, more preferably no more than 10 wt %, and most preferably no more than 5 wt %, relative to the total weight of the porous precursor. Optionally, the porous precursor may comprise residual matrix metal component in an amount of at least 0.01 wt %, at least 0.1 wt %, at least 0.5 wt %, at least 1 wt %, at least 2 wt %, or at least 3 wt %, relative to the total weight of the particulate material. As noted above, aluminium is a preferred matrix metal, and residual aluminium may form part of the electroactive material of the porous precursors formed according to this process.

Processes for obtaining porous silicon via stain etching are described, for example, by Huang et al., Adv. Mater., 2011, 23, pp. 285-308 and by Chartier et al., Electrochimica Acta, 2008, 53, pp. 5509-5516.

Processes for obtaining porous silicon via reduction of silica are described, for example, by Yu et al., Advanced Materials, 2010, 22, 2247-2250, in WO2013/179068, and in US 2008/038170.

The process of the invention may optionally comprise assembling the porous particles from a plurality of fragments as defined above, optionally together with one or more further components selected from conductive additives, structural additives, pore forming materials and additional particulate electroactive materials.

Conductive additives may be included in the particulate material prepared according to the process of the invention so as to improve electrical conductivity between the electroactive material-containing components of the porous particles. The conductive additives may suitably be selected from carbon black, carbon fibres, carbon nanotubes, acetylene black, ketjen black, metal fibres, metal powders and conductive metal oxides. Preferred conductive additives include carbon black and carbon nanotubes.

One or more conductive additives may suitably be present in a total amount of from 1 to 20 wt %, preferably 2 to 15 wt % and most preferably 5 to 10 wt %, based on the total weight of the porous particles.

Structural additives may be included to improve the structural strength of the porous particles and reduce fracturing during subsequent handling and incorporation into electrode coatings. Such structural additives may suitably be selected from silica, ceramics, metal alloys and metal oxides. The structural additives may also be included to provide compressible regions of the porous particles to counteract the expansion of the electroactive materials during metal ion insertion. Such structural additives may suitably be selected from compressible polymers, graphite, graphene and graphene oxides.

One or more structural additives may suitably be present in a total amount of from 0.5 to 20 wt %, preferably 1 to 15 wt % and most preferably 2 to 10 wt %, based on the total weight of the porous particles.

Additional particulate electroactive materials which may be incorporated into the porous particles include silicon-, tin-, germanium- and/or aluminium-containing particles having a different morphology to the fragments defined herein. Such particles may for instance be in the form of wires, rods, sheets, ribbons, spheres, cuboids and pillared particles, and may be substantially non-porous. Further examples of additional particulate electroactive materials include graphite, hard carbon, graphene, graphene platelets, graphene oxides, gallium and lead particles. Additional particulate electroactive materials incorporated into the porous particles preferably have a D₅₀ particle diameter of less than 2 μm, more preferably less than 1.5 μm, more preferably less than 1 μm, for example less than 800 nm or less than 500 nm.

One or more additional electroactive materials may suitably be present in an amount of up to 50 wt %, for example, up to 40 wt %, up to 30 wt %, up to 20 wt %, up to 10 wt %, or up to 5 wt %, based on the total weight of the porous particles.

In other embodiments, the process of the invention may comprise assembling the porous particles substantially without including electroactive materials other than the fragments as defined herein. For example, any additional electroactive materials may be present in an amount of no more than 10 wt %, no more than 5 wt %, no more than 2 wt % or no more than 1 wt %, based on the total weight of the porous particles. Thus, the fragments may be substantially the only source of electroactive material to be assembled into the porous particles.

A component may provide more than one function, for example, conductive additives or additional electroactive materials listed herein may also act as a structural additive.

The process of the invention may optionally comprise assembling the porous particles in the presence of a binder. A binder may suitably be present in an amount of up to 10 wt % based on the total weight of the porous particles. The binder may be polymeric or non-polymeric or a combination of one or more polymers or non-polymers.

Examples of polymeric binders which may be used in accordance with the present invention include polymeric binders, such as polyvinylidene fluoride (PVDF), polyacrylic acid (PAA) and alkali metal salts thereof, modified polyacrylic acid (mPAA) and alkali metal salts thereof, carboxymethylcellulose (CMC), modified carboxymethylcellulose (mCMC), sodium carboxymethylcellulose (Na-CMC), polyvinylalcohol (PVA), alginates and alkali metal salts thereof, styrene-butadiene rubber (SBR), polyimide and polydopamine.

Further examples of binders which may be used in accordance with the present invention include carbonised binders. Carbonised binders are obtained from carbonisable precursors which are converted to carbon by heating the porous particles to a temperature above the decomposition temperature of the carbonisable precursors, for instance in the range of from 600 to 1000° C. Examples of suitable carbonisable precursors for the formation of carbonised binders include sugars and polysaccharides (e.g. sucrose, dextran or starch), petroleum pitch, and polymers such as those mentioned above. The carbonisable precursors are suitably used in an amount appropriate to provide up to 10 wt % of carbonised binder based on the total weight of the porous particles after carbonisation of the carbonisable precursor. For example, the carbonisable precursors may suitably be used in an amount of up to 40 wt %, up to 30 wt %, up to 20 wt % or up to 10 wt % based on the total weight of the porous particles before carbonisation of the carbonisable precursor.

The use of carbonised binders may be preferred since it provides a carbon layer that coats at least a portion of the fragments, which is believed to assist in controlling the formation of SEI layers on the surface of the electroactive material and in improving the conductivity of the porous particles.

The porous particles may in principle be assembled using any known process for the production of composite particles from fine particulate precursors. Suitable processes include spray drying, agglomeration, granulation, lyophilisation (including freeze drying), freeze granulation, spray-freezing into liquid, spray pyrolysis, electrostatic spraying, emulsion polymerisation and self-assembly of particles in solution. The porous particles may be assembled together with a removable pore forming material.

Pore forming materials are particulate components which are initially contained within the porous particles during manufacture and are then at least partially removed to leave pores in their place. The pore forming materials may be at least partially removed by evaporation, disintegration, heat treatment, etching or washing processes. Pore forming materials may be included to introduce additional porosity and/or to control the size of pores and/or their distribution within the porous particles. The pore forming materials may suitably be selected from silica, metal oxides, salts (including NaCl), and thermodegrading materials that at least partially decompose into volatile components when heated leaving behind minimal char or residue (including polystyrene, cellulose ethers, acrylic polymers, PMMA, starch, poly(alkylene) carbonates, polypropylene carbonate (PPC) and polyethylene carbonate (PEC)). Suitable pore forming materials include those having a particle size in the range of from 10 to 500 nm. Sodium chloride is a preferred pore forming additive since sodium chloride nanocrystals may be formed in situ during assembly of the porous particles (e.g. by spray drying) and may then easily be removed by dissolving in water.

A preferred process for preparing the porous particles is spray drying in view of the control over particle size and particle size distribution afforded by this technique. Spray drying is a process for producing a dry powder from a liquid or slurry by dispersing the liquid or slurry through an atomizer or spray nozzle to form a spray of droplets of controlled drop size, which are then rapidly dried using a hot gas to form a plurality of generally spheroidal particles in the form of a free-flowing powder.

Thus, in a preferred embodiment, the process of the invention comprises assembling the porous particles by forming a slurry comprising the fragments and optionally any conductive additives and/or structural additives and/or additional particulate electroactive materials and/or binders together with a vaporisable liquid carrier, and spray drying the slurry to form the particulate material consisting of a plurality of porous particles. Suitable vaporisable liquid carriers for the slurry include water and organic solvents, such as ethanol. In some embodiments, a slurry comprising fragments obtained from a wet ball milling process as defined above may be diluted as appropriate and then used directly in the spray drying process. The spray drying step may be replaced by one or more alternative process such as agglomeration, granulation, lyophilisation (including freeze drying), freeze granulation, spray-freezing into liquid, spray pyrolysis, electrostatic spraying, emulsion polymerisation and self-assembly of particles in solution, to form the composite porous particles from the slurry.

In a preferred embodiment, the process of the invention may comprise assembling the porous particles by forming a slurry comprising the fragments and optionally any conductive additives and/or additional particulate electroactive materials and/or binders and water as a liquid carrier, and spray drying the slurry to form the particulate material consisting of a plurality of porous particles. In accordance with this embodiment of the invention, it is found that the fragments may form bonding interactions that bind the porous particles together, and thus the need for a binder may be negated. More specifically, it is believed that oxygen atoms, e.g. from a native oxide layer on the surface of the fragments, form covalent bonds bridging the individual fragments. This hypothesis is supported by experiments in which the porous particles thus formed are exposed to HF and are found to disintegrate. It is believed that this is due to cleavage of M-O-M bonds between the constituent fragments of the porous particles, where M represents silicon, germanium, tin or aluminium, and preferably silicon.

In accordance with this embodiment of the invention, it is thus preferred that the fragments are provided with a native oxide layer, for example having a thickness of at least 0.5 nm, e.g. at least 1 nm. It will of course be appreciated that unless scrupulous care is taken to exclude air/oxygen at all stages during the preparation of the porous precursor, the formation of the fragments and the assembly of the fragments into porous particles, then the fragments will in any case usually have a native oxide formed on their surfaces.

In order to promote the formation of bonding interactions between the individual fragments, it is preferred in accordance with this embodiment of the invention that the fragments have a high content of the electroactive material. Preferably the fragments comprise at least 80 wt %, more preferably at least 85 wt %, and most preferably at least 90 wt % of the electroactive material. For example, the fragments may comprise at least 95 wt %, at least 98 wt %, or at least 99 wt % of the electroactive material.

More preferably, the fragments have a high content of silicon. Preferably the fragments comprise at least 80 wt %, more preferably at least 85 wt %, and most preferably at least 90 wt % of silicon. For example, the fragments may comprise at least 95 wt %, at least 98 wt %, or at least 99 wt % of silicon.

It is also preferred in accordance with this embodiment of the invention that the porous particles comprise a high content of the porous particle fragments. Preferably the porous particles comprise at least 80 wt %, more preferably at least 85 wt %, and most preferably at least 90 wt % of the fragments. For example, the porous particles may comprise at least 95 wt %, at least 98 wt %, or at least 99 wt % of the porous particle fragments.

In accordance with this embodiment of the invention, the porous particles may be free of additional binder(s).

In a second aspect, the present invention provides a particulate material consisting of a plurality of porous particles comprising at least 30% by weight of an electroactive material selected from silicon, tin, germanium, aluminium or a mixture thereof, wherein the porous particles comprise an assembly of a plurality of fragments comprising the electroactive material, wherein the fragments are obtainable via the fragmentation of a porous precursor comprising the electroactive material.

The particulate material according to the second aspect of the invention may be obtained according to the process of the first aspect of the invention. Any feature described as preferred or optional with reference to the particles obtainable according to the first aspect of the invention shall be understood as a preferred or optional feature of the particles of the second aspect of the invention. In particular, the fragments constituting the porous particles of the second aspect of the invention may have any of the features defined above with reference to the first aspect of the invention. Likewise, any feature described as preferred or optional with reference to the particles of the second aspect of the invention shall be understood as a preferred or optional feature of the particles obtainable according to the first aspect of the invention.

The porous particles of the second aspect of the invention (and/or obtainable according to the first aspect of the invention) preferably comprise at least 50 wt % of the fragments, more preferably at least 60 wt %, more preferably at least 70 wt % and most preferably at least 75 wt %. In some embodiments, the porous particles may comprise at least 80 wt % of the fragments, for example at least 85 wt %, at least 90 wt %, at least 95 wt %, at least 98 wt % or at least 99 wt %.

The porous particles preferably comprise at least 40 wt %, more preferably at least 50 wt %, more preferably at least 60 wt %, more preferably at least 70 wt %, more preferably at least 75 wt %, more preferably at least 80 wt %, and most preferably at least 85 wt % of the electroactive material. For example, the porous particles may comprise at least 90 wt %, at least 95 wt %, at least 98 wt %, or at least 99 wt % of the electroactive material.

Preferred components of the electroactive material are silicon, germanium and tin. Thus, the porous particles preferably comprise at least 40 wt %, more preferably at least 50 wt %, more preferably at least 60 wt %, more preferably at least 70 wt %, more preferably at least 75 wt %, more preferably at least 80 wt %, and most preferably at least 85 wt % of one or more of silicon, germanium and tin. For example, the porous particles may comprise at least 90 wt %, at least 95 wt %, at least 98 wt %, or at least 99 wt % of one or more of silicon, germanium and tin.

A particularly preferred component of the electroactive material is silicon. Thus, the porous particles may comprise at least 40 wt %, more preferably at least 50 wt %, more preferably at least 60 wt %, more preferably at least 70 wt %, more preferably at least 75 wt %, more preferably at least 80 wt %, and most preferably at least 85 wt % of silicon. For example, the porous particles may comprise at least 90 wt %, at least 95 wt %, at least 98 wt %, or at least 99 wt % of silicon.

The porous particles of the second aspect of the invention may optionally comprise one or more further components selected from conductive additives, structural additives and additional particulate electroactive materials. Suitable conductive additives, structural additives and additional particulate electroactive materials are discussed above.

The porous particles may comprise one or more conductive additives in a total amount of from 1 to 20 wt %, preferably 2 to 15 wt % and most preferably 5 to 10 wt %, based on the total weight of the porous particles.

The porous particles may comprise one or more structural additives in a total amount of from 0.5 to 20 wt %, preferably 1 to 15 wt % and most preferably 2 to 10 wt %, based on the total weight of the porous particles.

The porous particles may comprise one or more additional electroactive materials in an amount of up to 50 wt %, for example, up to 40 wt %, up to 30 wt %, up to 20 wt %, up to 10 wt %, or up to 5 wt %, based on the total weight of the porous particles. Alternatively, the porous particles may be substantially free of electroactive materials other than the fragments as defined herein. For example, any additional electroactive materials may be present in an amount of no more than 10 wt %, no more than 5 wt %, no more than 2 wt % or no more than 1 wt %, based on the total weight of the porous particles.

The porous particles may comprise one or more binders to bind together the plurality of fragments in each particle. Suitable binders and amounts thereof are discussed above. In other embodiments, the porous particles of the invention may be substantially free of additional binders.

In some embodiments, the plurality of fragments in each particle may be bound together via covalent or non-covalent interactions between oxide layers on the surfaces of adjacent fragments, e.g. M-O-M covalent bonds as described above.

In the embodiments of the invention in which the plurality of fragments in each particle may be bound together via interactions between oxide layers on the surfaces of adjacent fragments, the fragments preferably comprise at least 80 wt %, more preferably at least 85 wt %, and most preferably at least 90 wt % of the electroactive material. For example, the fragments may comprise at least 95 wt %, at least 98 wt %, or at least 99 wt % of the electroactive material. More preferably, the fragments have a high content of silicon. Preferably the fragments comprise at least 80 wt %, more preferably at least 85 wt %, and most preferably at least 90 wt % of silicon. For example, the fragments may comprise at least 95 wt %, at least 98 wt %, or at least 99 wt % of silicon.

It is also preferred in the embodiments of the invention in which the plurality of fragments in each particle may be bound together via interactions between oxide layers on the surfaces of adjacent fragments that the porous particles comprise a high content of the porous particle fragments. Preferably the porous particles comprise at least 80 wt %, more preferably at least 85 wt %, and most preferably at least 90 wt % of the fragments. For example, the porous particles may comprise at least 95 wt %, at least 98 wt %, or at least 99 wt % of the porous particle fragments.

Porous particles according to the invention in which the plurality of fragments in each particle may be bound together via covalent or non-covalent interactions between oxide layers on the surfaces of adjacent fragments may be characterised in that the particles disintegrate on exposure to HF.

The porous particles preferably have a D₅₀ particle diameter of at least 1 μm, more preferably at least 1.5 μm, more preferably at least 2 μm, more preferably at least 2.5 μm, and most preferably at least 3 μm.

The porous particles preferably have a D₅₀ particle diameter no more than 25 μm, more preferably no more than 20 μm, more preferably no more than 18 μm, more preferably no more than 15 μm, and most preferably no more than 12 μm.

The D₁₀ particle diameter of the porous particles is preferably at least 200 nm, more preferably at least 500 nm, and most preferably at least 800 nm, for example at least 1 μm, at least 2 μm, or at least 3 μm. By maintaining the D₁₀ particle diameter at 1 μm or more, the potential for undesirable agglomeration of sub-micron sized particles is reduced, resulting in improved dispersibility of the particulate material in slurries.

The D₉₀ particle diameter of the porous particles is preferably no more than 40 μm, more preferably no more than 30 μm, more preferably no more than 25 μm, and most preferably no more than 20 μm.

The D₉₉ particle diameter of the porous particles is preferably no more than 50 μm, more preferably no more than 40 μm, more preferably no more than 30 μm, and most preferably no more than 25 μm.

Within the general ranges of particle diameter provided above, two particular particle populations can be identified having particular (but not exclusive) suitability for use in hybrid anodes and non-hybrid/high-loading anodes, respectively.

For use in hybrid anodes, the porous particles suitably have a D₅₀ particle diameter in the range of from 1 to 7 μm. Preferably, the D₅₀ particle diameter is at least 1.5 μm, more preferably at least 2 μm, more preferably at least 2.5 μm, and most preferably at least 3 μm. Preferably, the D₅₀ particle diameter is no more than 6 μm, more preferably no more than 5 μm, more preferably no more than 4.5 μm, more preferably no more than 4 μm, and most preferably no more than 3.5 μm. Particles having these dimensions are ideally suited to locate themselves in the void spaces between spheroidal synthetic graphite particles with particle diameters in the range of from 10 to 25 μm, as conventionally used to fabricate the anodes of commercial lithium-ion batteries.

For use in hybrid anodes, the porous particles preferably have a D₁₀ particle diameter of at least 500 nm, more preferably at least 800 nm. When the D₅₀ particle diameter is at least 1.5 μm, the D₁₀ particle diameter is preferably at least 800 nm, more preferably at least 1 μm. When the D₅₀ particle diameter is at least 2 μm, the D₁₀ particle diameter is preferably at least 1 μm and most preferably at least 1.5 μm.

For use in hybrid anodes, the porous particles preferably have a D₉₀ particle diameter of no more than 12 μm, more preferably no more than 10 μm, more preferably no more than 8 μm. When the D₅₀ particle diameter is no more than 6 μm, the D₉₀ particle diameter is preferably no more than 10 μm, more preferably no more than 8 μm. When the D₅₀ particle diameter is no more than 5 μm, the D₉₀ particle diameter is preferably no more than 7.5 μm, more preferably no more than 7 μm. When the D₅₀ particle diameter is no more than 4 μm, the D₉₀ particle diameter is preferably no more than 6 μm, more preferably no more than 5.5 μm.

For use in hybrid anodes, the porous particles preferably have a D₉₉ particle diameter of no more than 20 μm, more preferably no more than 15 μm, and most preferably no more than 12 μm. When the D₅₀ particle diameter is no more than 6 μm, the D₉₀ particle diameter is preferably no more than 15 μm, more preferably no more than 12 μm. When the D₅₀ particle diameter is no more than 5 μm, the D₉₀ particle diameter is preferably no more than 12 μm, more preferably no more than 9 μm.

For use in non-hybrid anodes, the porous particles preferably have a D₅₀ particle diameter in the range of from greater than 5 to 25 μm. Preferably, the D₅₀ particle diameter is at least 6 μm, more preferably at least 7 μm, more preferably at least 8 μm, and most preferably at least 10 μm. Preferably, the D₅₀ particle diameter is no more than 20 μm, more preferably no more than 18 μm, more preferably no more than 15 μm, and most preferably no more than 12 μm. Particles within this size range are particularly suited to the formation of dense electrode layers of uniform thickness in the conventional range of from 20 to 50 μm.

For use in non-hybrid anodes, the D₁₀ particle diameter of the porous particles is preferably at least 1 μm, more preferably at least 2 μm, and most preferably at least 3 μm.

For use in non-hybrid anodes, the D₉₀ particle diameter of the porous particles is preferably no more than 40 μm, more preferably no more than 30 μm, more preferably no more than 25 μm, and most preferably no more than 20 μm. It has been found that larger particles having a size above 40 μm may be less physically robust and less resistant to mechanical stress during repeated charging and discharging cycles. In addition, larger particles are less suitable for forming dense electrode layers, particularly electrode layers having a thickness in the range of from 20 to 50 μm.

For use in non-hybrid anodes, the D₉₉ particle diameter of the porous particles is preferably no more than 50 μm, more preferably no more than 40 μm, more preferably no more than 30 μm, and most preferably no more than 25 μm.

Preferably, the porous particles have a narrow size distribution span. For instance, the particle size distribution span (defined as (D₉₀−D₁₀)/D₅₀) is preferably 5 or less, more preferably 4 or less, more preferably 3 or less, more preferably 2 or less and most preferably 1.5 or less. By maintaining a narrow size distribution span, the concentration of particles in the size range found by the inventors to be most favourable for use in electrodes is maximised.

The intra-particle porosity of the porous particles is preferably at least 30%, more preferably at least 40%, most preferably at least 50% for example at least 60%, or at least 70%. The intra-particle porosity is preferably no more than 90%, more preferably no more than 88%, more preferably no more than 86%, more preferably no more than 85%, or less than 75%.

Preferably the porous particles have a substantially open and connected porous structure such that substantially all of the pore volume of the porous particles is accessible to a fluid from the exterior of the particle, for instance to a gas or to an electrolyte. By a substantially open porous structure, it is meant that at least 90%, preferably at least 95%, preferably at least 98%, preferably at least 99% of the pore volume of the porous particles is accessible to a fluid from the exterior of the particles.

For the avoidance of doubt, intra-particle porosity values as specified or reported herein shall be understood as referring to the volume of open pores, i.e. pores that are accessible to a fluid from the exterior of the particles of the invention. Fully enclosed pores which cannot be identified by mercury porosimetry shall not be taken into account herein when specifying or reporting intra-particle porosity.

The particulate material of the invention is preferably characterised not only by the overall porosity of the porous particles, but also by the way that the porosity is distributed in the particles. As noted above, the fragments preferably have a structure which is sufficiently robust to maintain structural integrity during assembly of the porous particles of the invention and subsequent processing of the particulate material into electrode layers, but not so large that the porous particle fragments undergo unacceptable stress during charging and discharging when the particulate material of the invention is used as an electroactive material. The size and distribution of the pores should also be such that the space for expansion of the electroactive material is evenly distributed in the region of the electroactive material within the porous particles. This structure of the fragments is reflected in the distribution of pores in the particulate material obtainable according to the process of the invention.

The particulate material of the invention is characterised by having at least two peaks in the pore diameter distribution as determined by mercury porosimetry; at least one peak at lower pore size being associated with intra-particle pores and at least one peak at higher pore size being associated with inter-particle porosity. The particulate material prepared according to the process of the invention preferably has a pore diameter distribution having a peak corresponding to the intra-particles pores in the range of from 30 nm to less than 500 nm as determined by mercury porosimetry.

The particulate material of the invention preferably has a pore diameter distribution having at least one peak at a pore size less than 400 nm, more preferably less than 300 nm, more preferably less than 200 nm, most preferably less than 150 nm, as determined by mercury porosimetry. Preferably, the pore diameter distribution has at least one peak at a pore size of more than 20 nm, more preferably more than 30 nm, more preferably more than 50 nm, as determined by mercury porosimetry. Preferably the particulate material of the invention has a single peak in the pore diameter distribution corresponding to the intra-particle pores, as determined by mercury porosimetry.

The particulate material of the invention preferably has an intra-particle pore diameter distribution with a peak pore diameter that is comparable to the average minimum dimension of the electroactive structural elements of the porous particle fragments. For example the particulate material of the invention preferably has an intra-particle peak pore diameter that is at least equal to the average minimum dimension of the structural elements, preferably the peak pore diameter is no more than three times larger than the average minimum dimension of the structural elements.

The particulate material of the invention may also be characterised by a peak in the pore diameter distribution of a loose packed plurality of particles relating to the inter-particle porosity at a pore diameter in the range of from 200 nm to 4 μm, as determined by mercury porosimetry.

It has been found that the overall porosity and the pore size distribution of the particulate material of the invention is associated with particularly good charge-discharge cycling properties when the particulate material is used as an electroactive material in anodes for metal-ion batteries. Without being bound by theory, it is believed that the particulate material prepared according to the process of the invention provides an optimum balance between overall porosity and pore size and pore distribution, thus providing sufficient void space within the particles to allow for inward expansion of the electroactive material during intercalation of metal ions. A suitably even distribution of pores within the particles together with a suitable pore size distribution enables highly efficient use to be made of the porosity in accommodating the expansion of the electroactive material, whilst also ensuring that the electroactive material architecture within the particles is sufficiently robust to withstand the mechanical strain during charging of the electroactive material to its maximum capacity and mechanical damage during particle manufacture and electrode assembly.

The porous particles of the invention are preferably spheroidal in shape. Spheroidal particles as defined herein may include both spherical and ellipsoidal particles and the shape of the porous particles of the invention may suitably be defined by reference to the sphericity and the aspect ratio of the particles. Spheroidal particles are found to be particularly well-suited to dispersion in slurries without the formation of agglomerates. In addition, the use of porous spheroidal particles is surprisingly found to provide a further improvement in capacity retention when compared to porous particles and porous particle fragments of irregular morphology.

The sphericity of an object is conventionally defined as the ratio of the surface area of a sphere to the surface area of the object, wherein the object and the sphere have identical volume. However, in practice it is difficult to measure the surface area and volume of individual particles at the micron scale. However, it is possible to obtain highly accurate two-dimensional projections of micron scale particles by scanning electron microscopy (SEM) and by dynamic image analysis, in which a digital camera is used to record the shadow projected by a particle. The term “sphericity” as used herein shall be understood as the ratio of the area of the particle projection to the area of a circle, wherein the particle projection and circle have identical circumference. Thus, for an individual particle, the sphericity S may be defined as:

$$S = \frac{4 \cdot π \cdot {A}_{m}}{{( {C}_{m} )}^{2}}$$

wherein Aₘ is the measured area of the particle projection and Cₘ is the measured circumference of the particle projection. The average sphericity Sₐᵥ of a population of particles as used herein is defined as:

$${S}_{av} = \frac{1}{n} {\sum }_{i = 1}^{n} [ \frac{4 \cdot π \cdot {A}_{m}}{{( {C}_{m} )}^{2}} ]$$

wherein n represents the number of particles in the population.

It will be understood that the circumference and area of a two-dimensional particle projection will depend on the orientation of the particle in the case of any particle which is not perfectly spheroidal. However, the effect of particle orientation may be offset by reporting sphericity and aspect ratios as average values obtained from a plurality of particles having random orientation. A number of SEM and dynamic image analysis instruments are commercially available, allowing the sphericity and aspect ratio of a particulate material to be determined rapidly and reliably. Unless stated otherwise, sphericity values as specified or reported herein are as measured by a CamSizer XT particle analyzer from Retsch Technology GmbH. The CamSizer XT is a dynamic image analysis instrument which is capable of obtaining highly accurate distributions of the size and shape for particulate materials in sample volumes of from 100 mg to 100 g, allowing properties such as average sphericity and average aspect ratio to be calculated directly by the instrument.

As used herein, the term “spheroidal” as applied to the porous particles of the invention shall be understood to refer to a material having an average sphericity of at least 0.70. Preferably, the porous spheroidal particles of the invention have an average sphericity of at least 0.85, more preferably at least 0.90, more preferably at least 0.92, more preferably at least 0.93, more preferably at least 0.94, more preferably at least 0.95, more preferably at least 0.96, more preferably at least 0.97, more preferably at least 0.98 and most preferably at least 0.99.

The average aspect ratio of the porous particles of the invention is preferably less than 3:1, more preferably no more than 2.5:1, more preferably no more than 2:1, more preferably no more than 1.8:1, more preferably no more than 1.6:1, more preferably no more than 1.4:1 and most preferably no more than 1.2:1. As used herein, the term “aspect ratio” as applied to the porous particles of the invention refers to the ratio of the longest dimension to the shortest dimension of a two-dimensional particle projection. The term “average aspect ratio” refers to a number-weighted mean average of the aspect ratios of the individual particles in the particle population.

Control of the BET surface area of electroactive material is an important consideration in the design of anodes for metal ion batteries. A BET surface area which is too low results in unacceptably low charging rate and capacity due to the inaccessibility of the bulk of the electroactive material to metal ions in the surrounding electrolyte. However, a very high BET surface area is also known to be disadvantageous due to the formation of a solid electrolyte interphase (SEI) layer at the anode surface during the first charge-discharge cycle of the battery. SEI layers are formed due to reaction of the electrolyte at the surface of electroactive materials and can consume significant amounts of metal ions from the electrolyte, thus depleting the capacity of the battery in subsequent charge-discharge cycles. While previous teaching in the art focuses on an optimum BET surface area below about 10 m²/g, the present inventors have found that a much wider BET range can be tolerated when using the particulate material obtainable according to the process of the invention as an electroactive material.

The particulate material of the invention preferably has a BET surface area of less than 300 m²/g, more preferably less than 250 m²/g, more preferably less than 200 m²/g, more preferably less than 150 m²/g, more preferably less than 120 m²/g. The particulate material of the invention may have a BET surface area of less than 100 m²/g, for example less than 80 m²/g. Suitably, the BET surface area may be at least 10 m²/g, at least 11 m²/g, at least 12 m²/g, at least 15 m²/g, at least 20 m²/g, or at least 50 m²/g. The term “BET surface area” as used herein should be taken to refer to the surface area per unit mass calculated from a measurement of the physical adsorption of gas molecules on a solid surface, using the Brunauer-Emmett-Teller theory, in accordance with ASTM B922/10.

In a third aspect of the invention, there is provided a composition comprising a particulate material according to the second aspect of the invention and at least one other component. In particular, the particulate material of the second aspect of the invention may be used as a component of an electrode composition. Thus, there is provided an electrode composition comprising a particulate material according to the second aspect of the invention and at least one other component selected from: (i) a binder; (ii) a conductive additive; and (iii) an additional particulate electroactive material. The particulate material used to prepare the electrode composition of the third aspect of the invention may have any of the features described as preferred or optional with regard to the second aspect of the invention and/or may be prepared by a process including any of the features described as preferred or optional with regard to the first aspect of the invention.

The electrode composition may optionally be a hybrid electrode composition which comprises a particulate material according to the second and/or third aspect of the invention and at least one additional particulate electroactive material.

Examples of additional particulate electroactive materials include graphite, hard carbon, aluminium and lead, as well as silicon-, tin-, germanium- and/or aluminium-containing particles having a different morphology to the particles of the invention. The at least one additional particulate electroactive material is preferably selected from graphite and hard carbon, and most preferably the at least one additional particulate electroactive material is graphite.

The at least one additional particulate electroactive material is preferably in the form of spheroidal particles having an average sphericity of at least 0.70, more preferably at least 0.85, more preferably at least 0.90, more preferably at least 0.92, more preferably at least 0.93, more preferably at least 0.94, and most preferably at least 0.95.

The at least one additional particulate electroactive material preferably has an average aspect ratio of less than 3:1, more preferably no more than 2.5:1, more preferably no more than 2:1, more preferably no more than 1.8:1, more preferably no more than 1.6:1, more preferably no more than 1.4:1 and most preferably no more than 1.2:1.

The at least one additional particulate electroactive material preferably has a D₅₀ particle diameter in the range of from 10 to 50 μm, preferably from 10 to 40 μm, more preferably from 10 to 30 μm and most preferably from 10 to 25 μm, for example from 15 to 25 μm. Where the at least one additional particulate electroactive material has a D₅₀ particle diameter within this range, the particulate material of the invention is advantageously adapted to occupy void space between the particles of the at least one additional particulate electroactive material, particularly where the particles of the at least one additional particulate electroactive material are spheroidal in shape.

In preferred embodiments, the at least one additional particulate electroactive material is selected from spheroidal carbon-comprising particles, preferably graphite particles and/or spheroidal hard carbon particles, wherein the graphite and hard carbon particles have a D₅₀ particle diameter in the range of from 10 to 50 μm. Still more preferably, the at least one additional particulate electroactive material is selected from spheroidal graphite particles, wherein the graphite particles have a D₅₀ particle diameter in the range of from 10 to 50 μm. Most preferably, the at least one additional particulate electroactive material is selected from spheroidal graphite particles, wherein the graphite particles have a D₅₀ particle diameter in the range of from 10 to 50 μm, and the particulate material according to the first and/or third aspect of the invention consists of porous spheroidal particles, as described above.

Where the electrode composition is a hybrid electrode composition, the particulate material preferably has one or more of the preferred D₅₀, D₅₀, D₉₀, and D₉₉ particle diameters disclosed above as being particularly suitable for use in hybrid electrodes.

The ratio of the at least one additional particulate electroactive material to the particulate material of the invention is suitably in the range of from 50:50 to 99:1 by weight, more preferably from 60:40 to 98:2 by weight, more preferably 70:30 to 97:3 by weight, more preferably 80:20 to 96:4 by weight, and most preferably 85:15 to 95:5 by weight.

The at least one additional particulate electroactive material and the particulate material of the invention together preferably constitute at least 50 wt %, more preferably at least 60 wt % more preferably at least 70 wt %, and most preferably at least 80 wt %, for example at least 85 wt %, at least 90 wt %, or at least 95 wt % of the total weight of the electrode composition.

Thus, the porous particles of the invention may be used to provide a hybrid anode having increased volumetric capacity when compared to an anode comprising only the graphite particles. In addition, the porous particles are sufficiently robust to survive manufacture and incorporation into an anode layer without loss of structural integrity, particularly when anode layers are calendered to produce a dense uniform layer, as is conventional in the art.

Where the electrode composition is a non-hybrid electrode composition, the particulate material of the invention preferably constitutes at least 50 wt %, more preferably at least 60 wt %, more preferably at least 70 wt %, and most preferably at least 80 wt %, for example at least 85 wt %, at least 90 wt %, or at least 95 wt % of the total weight of the electrode composition.

Where the electrode composition is a non-hybrid electrode composition, the particulate material may have one or more of the preferred D₁₀, D₅₀, D₉₀, and D₉₉ particle diameters disclosed above as being particularly suitable for use in non-hybrid electrodes.

The electrode compositions of the invention may optionally comprise a binder. A binder functions to adhere the electrode composition to a current collector and to maintain the integrity of the electrode composition. The binder is preferably a polymer-based binder. Examples of binders which may be used in accordance with the present invention include polyvinylidene fluoride (PVDF), polyacrylic acid (PAA) and alkali metal salts thereof, modified polyacrylic acid (mPAA) and alkali metal salts thereof, carboxymethylcellulose (CMC), modified carboxymethylcellulose (mCMC), sodium carboxymethylcellulose (Na-CMC), polyvinylalcohol (PVA), alginates and alkali metal salts thereof, styrene-butadiene rubber (SBR), and polyimide. The electrode composition may comprise a mixture of binders. Preferably, the binder comprises polymers selected from polyacrylic acid (PAA) and alkali metal salts thereof, and modified polyacrylic acid (mPAA) and alkali metal salts thereof, SBR and CMC.

The binder (exclusive of any binder that may be present in the porous particles) may suitably be present in an amount of from 0.5 to 20 wt %, preferably 1 to 15 wt % and most preferably 2 to 10 wt %, based on the total weight of the electrode composition.

The binder may optionally be present in combination with one or more additives that modify the properties of the binder, such as cross-linking accelerators, coupling agents and/or adhesive accelerators.

The electrode compositions of the invention may optionally comprise one or more conductive additives. Preferred conductive additives are non-electroactive materials which are included so as to improve electrical conductivity between the electroactive components of the electrode composition and between the electroactive components of the electrode composition and a current collector. The conductive additives may suitably be selected from carbon black, carbon fibres, carbon nanotubes, acetylene black, ketjen black, graphene, nano-graphene platelets, reduced graphene oxide, metal fibres, metal powders and conductive metal oxides. Preferred conductive additives include carbon black, carbon fibres, graphene and carbon nanotubes.

The one or more conductive additives may suitably be present in a total amount of from 0.5 to 20 wt %, preferably 1 to 15 wt % and most preferably 2 to 10 wt %, based on the total weight of the electrode composition.

In a fourth aspect, the invention provides an electrode comprising a particulate material as defined with reference to the second aspect of the invention in electrical contact with a current collector. The particulate material used to prepare the electrode composition of the fourth aspect of the invention may have any of the features described as preferred or optional with regard to the second aspect of the invention and/or may be prepared by a process including any of the features described as preferred or optional with regard to the first aspect of the invention.

As used herein, the term current collector refers to any conductive substrate which is capable of carrying a current to and from the electroactive particles in the electrode composition. Examples of materials that can be used as the current collector include copper, aluminium, stainless steel, nickel, titanium sintered carbon and alloys or laminated foils comprising the aforementioned materials. Copper is a preferred material. The current collector is typically in the form of a foil or mesh having a thickness of between 3 to 500 μm. The particulate material of the invention may be applied to one or both surfaces of the current collector to a thickness which is preferably in the range of from 10 μm to 1 mm, for example from 20 to 500 μm, or from 50 to 200 μm.

Preferably, the electrode comprises an electrode composition as defined with reference to the third aspect of the invention in electrical contact with a current collector. The electrode composition may have any of the features described as preferred or optional with regard to the third aspect of the invention. In particular, it is preferred that the electrode composition comprises one or more additional particulate electroactive materials as defined above.

The electrode of the fourth aspect of the invention may suitably be fabricated by combining the particulate material of the invention (optionally in the form of the electrode composition of the invention) with a solvent and optionally one or more viscosity modifying additives to form a slurry. The slurry is then cast onto the surface of a current collector and the solvent is removed, thereby forming an electrode layer on the surface of the current collector. Further steps, such as heat treatment to cure any binders and/or calendaring of the electrode layer may be carried out as appropriate. The electrode layer suitably has a thickness in the range of from 20 μm to 2 mm, preferably 20 μm to 1 mm, preferably 20 μm to 500 μm, preferably 20 μm to 200 μm, preferably 20 μm to 100 μm, preferably 20 μm to 50 μm.

Alternatively, the slurry may be formed into a freestanding film or mat comprising the particulate material of the invention, for instance by casting the slurry onto a suitable casting template, removing the solvent and then removing the casting template. The resulting film or mat is in the form of a cohesive, freestanding mass which may then be bonded to a current collector by known processes.

The electrode of the fourth aspect of the invention may be used as the anode of a metal-ion battery. Thus, in a fifth aspect, the present invention provides a rechargeable metal-ion battery comprising an anode, the anode comprising an electrode as described with reference to the fourth aspect of the invention, a cathode comprising a cathode active material capable of releasing and reabsorbing metal ions; and an electrolyte between the anode and the cathode.

The metal ions are preferably selected from lithium, sodium, potassium, calcium or magnesium. More preferably the rechargeable metal-ion battery of the invention is a lithium-ion battery, and the cathode active material is capable of releasing and lithium ions.

The cathode active material is preferably a metal oxide-based composite. Examples of suitable cathode active materials for a lithium-ion battery include LiCoO₂, LiCo_{0.99}Al_{0.01}O₂, LiNiO₂, LiMnO₂, LiCo_{0.5}Ni_{0.5}O₂, LiCo_{0.7}Ni_{0.3}O₂, LiCo_{0.8}Ni_{0.2}O₂, LiCo_{0.82}Ni_{0.18}O₂, LiCo_{0.8}Ni_{0.15}Al_{0.05}O₂, LiNi_{0.4}Co_{0.3}Mn_{0.3}O₂ and LiNi_{0.33}Co_{0.33}Mn_{0.34}O₂. The cathode current collector is generally of a thickness of between 3 to 500 μm. Examples of materials that can be used as the cathode current collector include aluminium, stainless steel, nickel, titanium and sintered carbon.

The electrolyte is suitably a non-aqueous electrolyte containing a metal salt, e.g. a lithium salt for a lithium-ion battery, and may include, without limitation, non-aqueous electrolytic solutions, solid electrolytes and inorganic solid electrolytes. Examples of non-aqueous electrolyte solutions that can be used include non-protic organic solvents such as propylene carbonate, ethylene carbonate, butylene carbonates, dimethyl carbonate, diethyl carbonate, gamma butyrolactone, 1,2-dimethoxyethane, 2-methyltetrahydrofuran, dimethylsulfoxide, 1,3-dioxolane, formamide, dimethylformamide, acetonitrile, nitromethane, methylformate, methyl acetate, phosphoric acid triesters, trimethoxymethane, sulfolane, methyl sulfolane and 1,3-dimethyl-2-imidazolidinone.

Examples of organic solid electrolytes include polyethylene derivatives polyethyleneoxide derivatives, polypropylene oxide derivatives, phosphoric acid ester polymers, polyester sulfide, polyvinylalcohols, polyvinylidine fluoride and polymers containing ionic dissociation groups.

Examples of inorganic solid electrolytes include nitrides, halides and sulfides of lithium salts such as Li₅NI₂, Li₃N, LiI, LiSiO₄, Li₂SiS₃, Li₄SiO₄, LiOH and Li₃PO₄.

The lithium salt for a lithium-ion battery is suitably soluble in the chosen solvent or mixture of solvents. Examples of suitable lithium salts include LiCl, LiBr, LiI, LiClO₄, LiBF₄, LiBC₄O₈, LiPF₆, LiCF₃SO₃, LiAsF₆, LiSbF₆, LiAlCl₄, CH₃SO₃Li and CF₃SO₃Li.

Where the electrolyte is a non-aqueous organic solution, the battery is preferably provided with a separator interposed between the anode and the cathode. The separator is typically formed of an insulating material having high ion permeability and high mechanical strength. The separator typically has a pore diameter of between 0.01 and 100 μm and a thickness of between 5 and 300 μm. Examples of suitable electrode separators include a micro-porous polyethylene film.

The separator may be replaced by a polymer electrolyte material and in such cases the polymer electrolyte material is present within both the composite anode layer and the composite cathode layer. The polymer electrolyte material can be a solid polymer electrolyte or a gel-type polymer electrolyte.

In a sixth aspect, the invention provides the use of a particulate material as defined with reference to the second aspect of the invention as an anode active material. Preferably, the particulate material is in the form of an electrode composition as defined with reference to the fourth aspect of the invention, and most preferably the electrode composition comprises one or more additional particulate electroactive materials as defined above.

The invention will now be described by way of examples and the accompanying figures, in which:

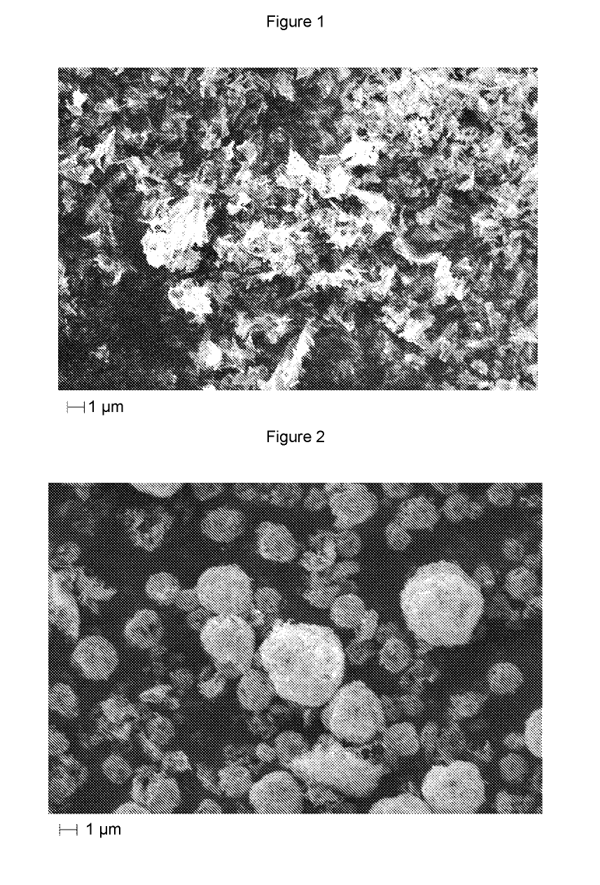

FIG. 1 is an SEM of porous precursor material prepared using the method described in example 2 having been milled for 30 minutes and having a D₅₀ of 1.4 μm.

FIG. 2 is a SEM of porous particles made by Example 3.

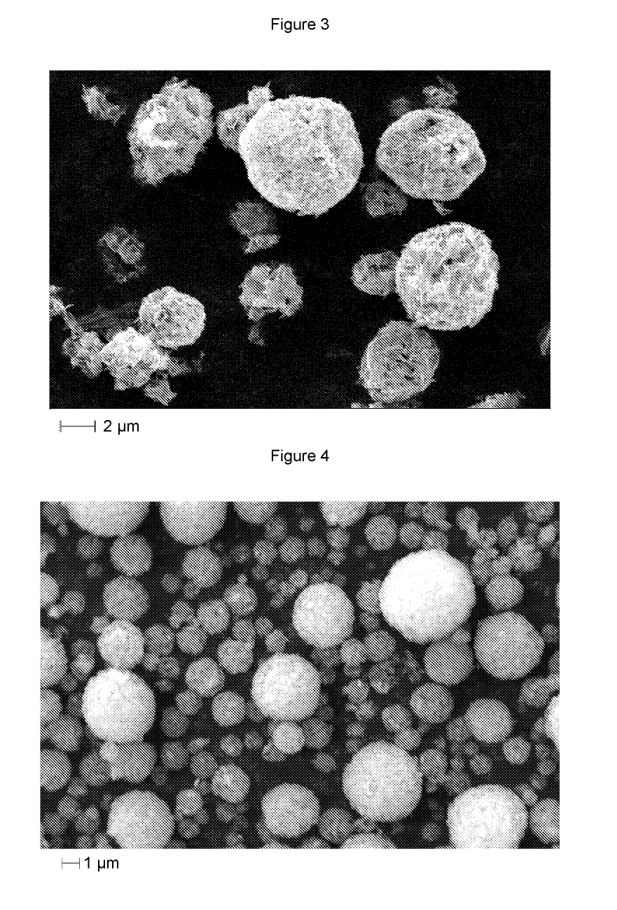

FIG. 3 is an SEM of porous particles made by Example 4.

FIG. 4 is an SEM of porous particles made by Example 5.

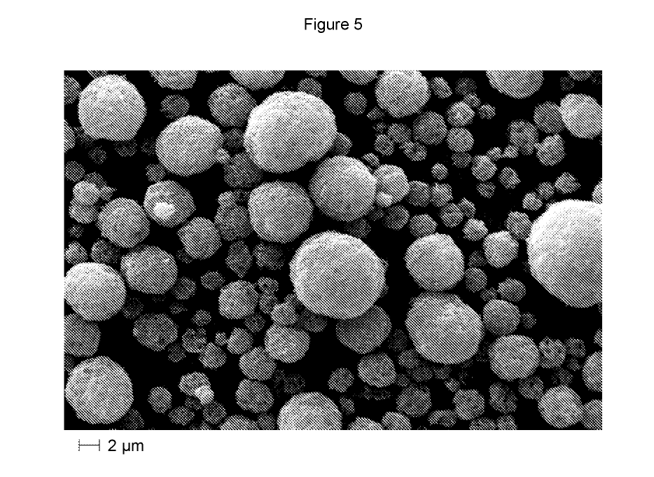

FIG. 5 is an SEM of porous particles made by Example 6.

### EXAMPLES

### Example 1—General Procedure for Preparation of Porous Particle Precursor

A powder of particles of an aluminium-silicon alloy (12.3 wt % silicon) having a D₁₀ particle diameter of 6.95 μm, a D₅₀ particle diameter of 17.50 μm, and a D₉₀ particle diameter of 36.6 μm and a BET value of 0.2 m²/g were obtained by gas atomisation of the molten alloy with a cooling rate of ca. 10⁵ K/s. The alloy particles contained 0.12 wt % iron and other metallic and carbon impurities in a total amount of less than 0.05 wt %.

The alloy particles were leached in multiple batches which were then combined after leaching. The alloy particles were slurried in deionised water (5 g per 50 mL) and the slurry was added to a 1 L stirred reactor containing aqueous HCl (450 mL, 6 M). The reaction mixture was stirred at ambient temperature for 20 minutes. The reaction mixture was then poured into deionised water (1 L) and the solid product was isolated by Buchner filtration. The product was dried in an oven at 75° C. before analysis. The porous precursor particles in each batch obtained after the leaching process had an elemental composition of 3-4 wt % Al, 0.4 wt % Fe, the remainder being silicon and native oxide. The BET value of the leached porous precursor particles in each batch was in the range of from 60-65 m²/g.

### Example 2—Fragmentation of Porous Precursor

A porous precursor prepared according to the procedure set out in Example 1 was fragmented by wet ball milling in multiple batches which were then combined after milling. The milling was carried out using 5.5 g of the porous precursor particles, 60 g H₂O and 200 g of zirconium oxide beads (1 mm) per batch in a Retsch PM200 Planetary ball mill operating at 100 rpm. In separate experiments, the ball milling was continued for periods of 15, 22.5, 30 and 45 minutes. The average fragment size distributions obtained in each case are shown in Table 1 below along with the corresponding dimensions of the porous precursor. D₅₀ values were typically found to vary by ±10% from one batch to another.

TABLE 1

| Average values: | D₁₀ (μm) | D₅₀ (μm) | D₉₀ (μm) |
|---|---|---|---|
| Precursor | 8.9 | 22.5 | 45.1 |

| | | | | |
|---|---|---|---|---|
| 15 | min | 0.66 | 2.3 | 6.9 |
| 22.5 | min | 0.53 | 1.6 | 4.1 |
| 30 | min | 0.47 | 1.3 | 3.5 |
| 45 | min | 0.39 | 1.0 | 2.6 |

### Example 3—Assembly of Porous Particles by Spray Drying without a Binder

Fragments obtained according to Example 2 by milling for 30 minutes were suspended in water (1% w/w fragments) and spray dried using an inlet temperature of 220° C., and outlet temperature of 113° C., a suspension feed rate of 500 mL/hr and a compressed air pressure of 50 mmHg with a nozzle diameter of 1.4 mm.

The particles formed by this process had D₁₀ particle diameter of 1.5 μm, a D₅₀ particle diameter of 3.1 μm, and a D₉₀ particle diameter of 6.4 μm and a BET value of 73 m²/g. Elemental analysis showed that the particles comprised 82% silicon, 3.7% aluminium, 0.34% iron and 14% oxygen by weight.

### Example 4—Assembly of Porous Particles by Spray Drying with a Sucrose Binder

Fragments obtained according to Example 2 by milling for 30 minutes were suspended in water with sucrose (1% w/w fragments, 5% w/w sucrose) and spray dried using an inlet temperature of 220° C., and outlet temperature of 113° C., a suspension feed rate of 500 mL/hr and a compressed air pressure of 50 mmHg with a nozzle diameter of 1.4 mm. The dried materials was then placed in an alumina crucible and heated at 10° C./min to 800° C. under flowing argon gas and held for two hours followed by cooling gradually over several hours. This pyrolyses the sucrose to produce a graphitic carbon binder/coating.

The particles formed by this process had D₁₀ particle diameter of 3.5 μm, a D₅₀ particle diameter of 7.4 μm, and a D₉₀ particle diameter of 14.4 μm and a BET value of 42 m²/g. Elemental analysis showed that the particles comprised 83.5% silicon, 3.7% aluminium, 0.34% iron, 9.7% oxygen and 2.6% carbon by weight.

### Example 5—Assembly of Porous Particles by Spray Drying with NaCl Pore Former

Fragments obtained according to Example 2 by milling for 45 minutes were suspended in water (1% w/w fragments) and sodium chloride was added (5% w/w sodium chloride). The mixtures was spray dried using an inlet temperature of 220° C., and outlet temperature of 113° C., a suspension feed rate of 500 mL/hr and a compressed air pressure of 50 mmHg with a nozzle diameter of 1.4 mm. The sodium chloride pore former was then extracted by dissolution in water.

The particles formed by this process had D₁₀ particle diameter of 1.9 μm, a D₅₀ particle diameter of 4.4 μm, and a D₉₀ particle diameter of 9.1 μm and a BET value of 52 m²/g.

### Example 6—Assembly of Porous Particles by Spray Drying with a Polydopamine Binder

Fragments obtained according to Example 2 by milling for 30 minutes were suspended in water with polydopamine (1% w/w fragments, 5% w/w polydopamine) and spray dried using an inlet temperature of 220° C., and outlet temperature of 113° C., a suspension feed rate of 500 mL/hr and a compressed air pressure of 50 mmHg with a nozzle diameter of 1.4 mm. The dried materials was then placed in an alumina crucible and heated at 10° C./min to 800° C. under flowing argon gas and held for two hours followed by cooling gradually over several hours. This pyrolyses the PAA to produce a graphitic carbon binder/coating.

The particles formed by this process had D₁₀ particle diameter of 3.1 μm, a D₅₀ particle diameter of 5.9 μm, and a D₉₀ particle diameter of 11.1 μm and a BET value of 42.4 m²/g. Elemental analysis showed that the particles comprised 79.9% silicon, 3.7% aluminium, 0.4% iron, 9.5% oxygen and 6.3% carbon by weight.

### Example 7—Process to Form Hybrid Electrode and Coin Cell Comprising the Porous Particles

A dispersion of conductive carbons (a mixture of carbon black, carbon fibres and carbon nanotubes) in water was mixed in a Thinky® mixer with the porous particles of Example 4 and spheroidal MCMB graphite (D₅₀=16.5 μm, BET=2 m²/g). A CMC/SBR binder solution (CMC:SBR ratio of 1:1) was then mixed in to prepare a slurry with a solids content of 40 wt % and a weight ratio of the porous particles:MCMB graphite:CMC/SBR:conductive carbon of 10:82.5:2.5:5. The slurry was then coated onto a 10 μm thick copper substrate (current collector) and dried at 50° C. for 10 minutes, followed by further drying at 120-180° C. for 12 hours to thereby form an electrode comprising an active layer on the copper substrate. Coin half cells were then made using circular electrodes of 0.8 cm radius cut from this electrode with a tonen separator, a lithium foil as the counter electrode and an electrolyte comprising 1M LiPF₆ in a 3:7 solution of EC/FEC containing 3 wt % vinylene carbonate. These half cells were used to measure the initial charge capacity and first cycle loss of the active layer and the expansion in thickness of the active layer at the end of the second charge (in the lithiated state). For expansion measurements, at the end of the first or second charge, the electrode was removed from the cell in a glove box and washed with DMC to remove any SEI layer formed on the active materials. The electrode thickness was measured before cell assembly and then after disassembly and washing. The thickness of the active layer was derived by subtracting the known thickness of the copper substrate. The volumetric energy density of the electrode, in mAh/cm³, was calculated from the initial charge capacity and the volume of the active layer in the lithiated state after the second charge.

### Comparative Example 1

A coin cell was made as described in Example 7 except that non-porous Silgrain™ silicon powder (from Elkem) was used instead of the porous particles. The silicon powder had a D₅₀ particle diameter of 4.1 μm, a D₁₀ particle diameter of 2.1 μm, and a D₉₀ particle diameter of 7.4 μm. The BET value was 2 m²/g and the particles had a silicon purity of 99.8 wt %.

### Comparative Example 2

A coin cell was made as described in Example 7 except that only graphite was used as the active material in the electrode. The electrode coating had a weight ratio of MCMB graphite:CMC/SBR:conductive carbon of 92.5:2.5:5.

### Results—Half Cells of Example 7 and Comparative Examples 1 and 2

| | First | Gravimetric | Volumetric energy | Capacity |
|---|---|---|---|---|
| Electrode | Cycle | Energy Density | density of | Retention |
| tested in | Loss | (mAh/g, 1st | electrode | after 10 Cycles |
| half cell | (%) | discharge) | (mAh/cm³) | (%) |
| Example 7 | 13.5 | 592 | 804 | 97 |
| Comp. Ex. | 13.2 | 669 | 777 | 63 |
| 1 | | | | |
| Comp. Ex. | 10.2 | 371 μm | 436 | 100 |
| 2 | | | | |

The values in the table are averages from three test cells of each type. Although the gravimetric energy density of the electrode of Example 7 is a little less than that of Comparative Example 1, it expands less and therefore has a larger volumetric energy density and a much better capacity retention. The electrode of Example 7 has a significantly higher volumetric energy density compare to the graphite-only electrode of Comparative Example 2.

### Example 8—Assembly of Porous Particles by Spray Drying with a Sucrose Binder

Fragments obtained according to Example 2 by milling for 30 minutes were suspended in water with sucrose (10% w/w fragments, 33% w/w sucrose) and spray dried using an inlet temperature of 150° C., a suspension feed rate of 5 mL/m. The dried materials were then placed in an alumina crucible and heated at 10° C./min to 800° C. under flowing argon gas and held for two hours followed by cooling gradually over several hours. This pyrolyses the sucrose to produce a graphitic carbon binder/coating.

The particles formed by this process had D₁₀ particle diameter of 3.27 μm, a D₅₀ particle diameter of 6.84 μm, a D₉₀ particle diameter of 17.3 and a BET value of 56.8 m²/g. Elemental analysis showed that the particles comprised 75.7% silicon, 3.7% aluminium, 0.3% iron, 14.8% oxygen and 6.8% carbon by weight.

### Comparative Example 3

Porous particles were obtained according to the process of Example 8, except that non-porous spherical silicon nanoparticles were used in place of the porous particle fragments of Example 2. The silicon nanoparticles had a diameter of 30-50 nm and a silicon purity of >98 wt % (sourced from Nanostructured and Amorphous Materials, Inc. USA). The particles formed by this process had D₁₀ particle diameter of 0.39 μm, a D₅₀ particle diameter of 4.26 μm, a D₉₀ particle diameter of 31.5 and a BET value of 57.3 m²/g. Elemental analysis showed that the particles comprised 79.4% silicon, 13.1% oxygen and 5.2% carbon by weight.

### Example 9—Process to Form Hybrid Electrode and Coin Cell Comprising the Porous Particles

A conductive carbon additive (carbon black) and a CMC binder solution were mixed in a Thinky® mixer and then the porous particles of Example 8 or Comparative Example 3 were added to the mix to prepare a slurry with a solids content of 40 wt % and a weight ratio of the porous particles:CMC/SBR:conductive carbon of 70:16:14. The slurry was then coated onto a 10 μm thick copper substrate (current collector) and dried at 50° C. for 10 minutes, followed by further drying at 120-180° C. for 12 hours to thereby form an electrode comprising an active layer having a coating density of 1.55 g/cm³ on the copper substrate. Coin cells were then made using circular electrodes of 0.8 cm radius cut from this electrode with a porous polyethylene separator, a LCO (lithium cobalt oxide) cathode with a coat weight of 3.7 g/cm³ as the counter electrode, and an electrolyte comprising 1M LiPF₆ in a 7:3 solution of EC/FEC (ethylene carbonate/fluoroethylene carbonate) containing 3 wt % vinylene carbonate.

These cells were used to measure the increase in thickness of the silicon-containing active layer at the end of the first charge (in the lithiated state). For expansion measurements, the change in thickness of the silicon-containing active layer was measured under loading (2 kgf/cm² equivalent to 19.6 N/cm²) using a one layer pouch type cell (one cathode and one anode). The percentage expansion of the silicon-containing anode was calculated by comparing the initial thickness of the cell and the thickness of the cell at full charge. Under the assumption that there is no change in thickness of other components of the cell (cathode, anode current collector, separator) the change of anode thickness may be estimated. The calculated increase in thickness of the active layer comprising the particles of Example 8 was 15%. The calculated increase in thickness of the active layer comprising the particles of Comparative Example 3 was 27%.

### Example 10—Process to Form High-Loading Electrode and Coin Cell Comprising the Porous Particles

A conductive carbon additive (carbon black) and a CMC binder solution were mixed in a Thinky® mixer and then the porous particles of Example 8 or Comparative Example 3 were added to the mixture to prepare a slurry with a solids content of 40 wt % and a weight ratio of the porous particles:CMC/SBR:conductive carbon of 70:16:14. The slurry was then coated onto a 10 μm thick copper substrate (current collector) and dried at 50° C. for 10 minutes, followed by further drying at 120-180° C. for 12 hours to thereby form an electrode comprising an active layer on the copper substrate. Coin cells were then made using circular electrodes of 0.8 cm radius cut from this electrode with a porous polyethylene separator, a LCO (lithium cobalt oxide) cathode with a coat weight of 3.7 g/cm³ as the counter electrode, and an electrolyte comprising 1M LiPF₆ in a 7:3 solution of EC/FEC (ethylene carbonate/fluoroethylene carbonate) containing 3 wt % vinylene carbonate.

Cell cycling tests were performed as follows. A constant current is applied at a rate of C/25 (wherein “C” represents the specific capacity of the anode in mAh, “25” refers to 25 hours), to lithiate the anode, with a cut off voltage of 4.2 V. When the cut off is reached, a constant voltage of 4.2 V is applied until a cut off current of C/100 is reached. The cell is then rested for 10 minutes in the lithiated state. The anode is then delithiated at a constant current of C/25 with a cut off voltage of 3V. The cell is then rested for 10 minutes. After this initial cycle, a constant current of C/2 is applied to lithiate the anode with a 4.2 V cut off voltage, followed by a 4.2 V constant voltage with a cut off current of C/40. The anode is then delithiated at a constant current of C/2 with a 3.0 V cut off. The cell is then rested for 5 minutes. This is then repeated for 30 cycles and the initial and final capacity of the silicon-containing electrode is measured. The following results are reported as an average across three cells of each type.

For electrodes containing the porous particles of Example 8, the initial capacity of the electrode is 1935.8 mAh and the capacity after 30 cycles is 1435.7 mAh, representing a capacity retention of 74.13%. For the electrodes containing the porous particles of Comparative Example 3, the initial capacity is higher at 2138.6 mAh. However, the capacity retention is significantly worse, such that after 30 cycles, the capacity is 1386.9 mAh, representing a capacity retention of 64.9% and a lower total retained capacity after 30 cycles which is less than that of the electrode according to the invention.

1. A process for preparing a particulate material consisting of a plurality of porous particles comprising at least 30% by weight of an electroactive material selected from silicon, tin, germanium, aluminium or a mixture thereof, the process comprising assembling the porous particles from a plurality of fragments comprising the electroactive material, wherein the fragments are obtainable via the fragmentation of a porous precursor comprising the electroactive material.

2. A process according to claim 1, wherein the fragments comprise at least 40 wt %, preferably at least 50 wt %, more preferably at least 60 wt %, more preferably at least 70 wt %, more preferably at least 75 wt %, more preferably at least 80 wt %, and most preferably at least 85 wt % of the electroactive material.

3. A process according to claim 1 or claim 2, wherein the fragments comprise at least 40 wt %, preferably at least 50 wt %, more preferably at least 60 wt %, more preferably at least 70 wt %, more preferably at least 75 wt %, more preferably at least 80 wt %, and most preferably at least 85 wt % of silicon.

4. A process according to claim 3, wherein the fragments comprise at least 60 wt % silicon and up to 40 wt % aluminium and/or germanium, preferably at least 70 wt % silicon and up to 30 wt % aluminium and/or germanium, more preferably at least 75 wt % silicon and up to 25 wt % aluminium and/or germanium, more preferably at least 80 wt % silicon and up to 20 wt % aluminium and/or germanium, more preferably at least 85 wt % silicon and up to 15 wt % aluminium and/or germanium, more preferably at least 90 wt % silicon and up to 10 wt % aluminium and/or germanium, and most preferably at least 95 wt % silicon and up to 5 wt % aluminium and/or germanium.

5. A process according to any one of the preceding claims, wherein the fragments comprise a minor amount of one or more additional elements selected from antimony, copper, magnesium, zinc, manganese, chromium, cobalt, molybdenum, nickel, beryllium, zirconium, iron, sodium, strontium, phosphorus, ruthenium, gold, silver, and oxides thereof.

6. A process according to any one of the preceding claims, wherein the fragments have a D₅₀ particle diameter of at least 300 nm, preferably at least 500 nm, optionally at least 800 nm or at least 1 μm.

7. A process according to any one of the preceding claims, wherein the fragments have a D₅₀ particle diameter of no more than 10 μm, preferably no more than 8 μm, more preferably no more than 6 μm, more preferably no more than 4 μm, more preferably no more than 2 μm, and most preferably no more than 1.5 μm.

8. A process according to any one of the preceding claims, wherein the fragments have a D₁₀ particle diameter of at least 100 nm, preferably at least 200 nm, more preferably at least 300 nm, and optionally at least 400 nm, at least 500 nm or at least 600 nm.

9. A process according to any one of the preceding claims, wherein the fragments have a D₉₀ particle diameter no more than 15 μm, preferably no more than 10 μm, more preferably no more than 8 μm, more preferably no more than 6 μm, and most preferably no more than 4 μm.

10. A process according to any one of the preceding claims, wherein the fragments have a fragment size distribution span of 5 or less, preferably 4 or less, preferably 3 or less, more preferably 2 or less and most preferably 1.5 or less.

11. A process according to any one of the preceding claims, wherein the fragments comprise a plurality of elongate structural elements having an average minimum dimension in the range of from 10 nm to 500 nm.

12. A process according to any one of the preceding claims, wherein the fragments comprise a plurality of elongate structural elements having an aspect ratio of at least 2:1, preferably at least 3:1, more preferably at least 4:1 and most preferably at least 5:1.

13. A process according to any one of the preceding claims, wherein the fragments are obtained from the fragmentation of a porous precursor comprising elongate structural elements having an average minimum dimension in the range of from 10 nm to 500 nm.

14. A process according to any one of the preceding claims, wherein the fragments are obtained from the fragmentation of a porous precursor comprising elongate structural elements having an aspect ratio of at least 2:1, preferably at least 3:1, more preferably at least 4:1 and most preferably at least 5:1.

15. A process according to any one of the preceding claims, wherein the fragments are obtained from the fragmentation of a porous precursor in the form of porous particles having a D₅₀ particle diameter in the range of from 5 μm to 5 mm.

16. A process according to any one of the preceding claims, wherein the fragments are obtained from the fragmentation of a porous precursor having internal porosity of at least 40%, preferably at least 50%, and most preferably at least 60%.

17. A process according to any one of the preceding claims, wherein the fragments are obtained from the fragmentation of a porous precursor having a pore diameter distribution having a peak corresponding to the internal or intra-particles pores in the range of from 50 nm to less than 500 nm as determined by mercury porosimetry.

18. A process according to any one of the preceding claims, wherein the fragments are obtained from wet ball milling of a porous precursor.

19. A process according to any one of the preceding claims, wherein the porous precursor is obtainable by leaching an alloy comprising silicon and/or germanium structures dispersed in a metal matrix.

20. A process according to any one of the preceding claims, wherein the porous particles are assembled from the plurality of fragments and one or more further components selected from conductive additives, structural additives, pore forming materials and additional particulate electroactive materials.

21. A process according to any one of the preceding claims, wherein the porous particles are assembled in the presence of a binder, preferably wherein the binder is a polymeric binder or a carbonisable binder.

22. A process according to any one of the preceding claims, wherein the porous particles are assembled by spray drying, agglomeration, granulation, lyophilisation, freeze granulation, spray-freezing into liquid, spray pyrolysis, electrostatic spraying, emulsion polymerisation and self-assembly of particles in solution.

23. A process according to claim 22, comprising forming a slurry comprising the fragments and optionally any conductive additives and/or structural additives and/or additional particulate electroactive materials and/or binders together with a vaporisable liquid carrier, and spray drying the slurry to form the particulate material consisting of a plurality of porous particles.

24. A process according to any one of the preceding claims, wherein the porous particles comprise at least 50 wt %, preferably at least 60 wt %, more preferably at least 70 wt % and most preferably at least 75 wt % of the fragments.

25. A process according to any one of the preceding claims, wherein the porous particles comprise at least 40 wt %, at least 50 wt %, preferably at least 60 wt %, more preferably at least 70 wt %, more preferably at least 75 wt %, more preferably at least 80 wt %, and most preferably at least 85 wt % of the electroactive material.

26. A process according to any one of claims 1 to 20, comprising forming a slurry comprising the fragments and water, wherein the fragments have a native oxide layer, and spray drying the slurry to form the particulate material consisting of a plurality of porous particles.

27. A process according to claim 26, wherein the porous particles are free of additional binders.

28. A process according to claim 26 or claim 27, wherein the fragments comprise at least 80 wt %, preferably at least 85 wt %, and most preferably at least 90 wt % of the electroactive material.

29. A process according to claim 28, wherein the fragments comprise at least 80 wt %, preferably at least 85 wt %, and most preferably at least 90 wt % of silicon.

30. A process according to any one of claims 26 to 29, wherein the porous particles comprise at least 80 wt %, preferably at least 85 wt %, and most preferably at least 90 wt % of the fragments.

31. A particulate material consisting of a plurality of porous particles comprising at least 30% by weight of an electroactive material selected from silicon, tin, germanium, aluminium or a mixture thereof, wherein the porous particles comprise an assembly of a plurality of fragments comprising the electroactive material, wherein the fragments are obtainable via the fragmentation of a porous precursor comprising the electroactive material.

32. A particulate material according to claim 31, wherein the fragments are as defined in any one of claims 1 to 19.

33. A particulate material according to claim 31 or claim 32, wherein the particulate material is obtained by a process as defined in any one of claims 1 to 30.

34. A particulate material according to any one of claims 31 to 33, wherein the porous particles comprise at least 50 wt %, preferably at least 60 wt %, more preferably at least 70 wt % and most preferably at least 75 wt % of the fragments.

35. A particulate material according to any one of claims 31 to 34, wherein the porous particles comprise at least 40 wt %, preferably at least 50 wt %, more preferably at least 60 wt %, more preferably at least 70 wt %, more preferably at least 75 wt %, more preferably at least 80 wt %, and most preferably at least 85 wt % of the electroactive material.

36. A particulate material according to any one of claims 31 to 35, wherein the porous particles comprise at least 40 wt %, preferably at least 50 wt %, more preferably at least 60 wt %, more preferably at least 70 wt %, more preferably at least 75 wt %, more preferably at least 80 wt %, and most preferably at least 85 wt % of one or more of silicon, germanium and tin.

37. A particulate material according to claim 36, wherein the porous particles comprise at least 40 wt %, preferably at least 50 wt %, more preferably at least 60 wt %, more preferably at least 70 wt %, more preferably at least 75 wt %, more preferably at least 80 wt %, and most preferably at least 85 wt % of silicon.

38. A particulate material according to any one of claims 31 to 37, wherein the porous particles comprise one or more further components selected from conductive additives, structural additives and additional particulate electroactive materials.

39. A particulate material according to any one of claims 31 to 38, wherein the porous particles comprise a binder, preferably wherein the binder is a polymeric binder or a carbonised binder.

40. A particulate material according to any one of claims 31 to 38, wherein the porous particles are substantially free of additional binders.

41. A particulate material according to claim 40, wherein the plurality of fragments in each porous particle are bound together via covalent or non-covalent interactions between oxide layers on the surfaces of adjacent fragments.

42. A particulate material according to claim 40 or claim 41, wherein the fragments comprise at least 80 wt %, preferably at least 85 wt %, and most preferably at least 90 wt % of the electroactive material.

43. A particulate material according to claim 42, wherein the fragments comprise at least 80 wt %, preferably at least 85 wt %, and most preferably at least 90 wt % of silicon.

44. A particulate material according to any one of claims 40 to 43, wherein the porous particles comprise at least 80 wt %, preferably at least 85 wt %, and most preferably at least 90 wt % of the fragments.

45. A particulate material according to any one of claims 40 to 44, characterised in that the porous particles disintegrate on exposure to HF.

46. A particulate material according to any one of claims 31 to 45, wherein the porous particles have a D₅₀ particle diameter of at least 1 μm, preferably at least 1.5 μm, more preferably at least 2 μm, more preferably at least 2.5 μm, and most preferably at least 3 μm.

47. A particulate material according to any one of claims 31 to 46, wherein the porous particles have a D₅₀ particle diameter of no more than 25 μm, preferably no more than 20 μm, more preferably no more than 18 μm, more preferably no more than 15 μm, and most preferably no more than 12 μm.

48. A particulate material according to any one of claims 31 to 47, wherein the porous particles have a D₁₀ particle diameter of at least 200 nm, preferably at least 500 nm, and most preferably at least 800 nm.

49. A particulate material according to any one of claims 31 to 48, wherein the porous particles have a D₉₀ particle diameter of no more than 40 μm, preferably no more than 30 μm, more preferably no more than 25 μm, and most preferably no more than 20 μm.

50. A particulate material according to any one of claims 31 to 49, wherein the porous particles have a D₉₉ particle diameter of no more than 50 μm, preferably no more than 40 μm, more preferably no more than 30 μm, and most preferably no more than 25 μm.

51. A particulate material according to any one of claims 31 to 50, wherein the porous particles have a size distribution span of 5 or less, preferably 4 or less, more preferably 3 or less, more preferably 2 or less and most preferably 1.5 or less.

52. A particulate material according to any one of claims 31 to 51, wherein the porous particles have an intra-particle porosity of at least 30%, preferably at least 40%, more preferably at least 50%, for example at least 60% or at least 70%.

53. A particulate material according to any one of claims 31 to 52, wherein the porous particles have an intra-particle porosity of no more than 90%, preferably no more than 88%, more preferably no more than 86%, more preferably no more than 85%.

54. A particulate material according to any one of claims 31 to 53, having a pore diameter distribution having a peak corresponding to the intra-particles pores in the range of from 20 nm to less than 400 nm as determined by mercury porosimetry.

55. A particulate material according to any one of claims 31 to 54, wherein the porous particles have an average sphericity of at least 0.85, preferably at least 0.90, more preferably at least 0.92, more preferably at least 0.93, more preferably at least 0.94, more preferably at least 0.95, more preferably at least 0.96, more preferably at least 0.97, more preferably at least 0.98 and most preferably at least 0.99.

56. A particulate material according to any one of claims 31 to 55, wherein the porous particles have an average aspect ratio of less than 3:1, preferably no more than 2.5:1, more preferably no more than 2:1, more preferably no more than 1.8:1, more preferably no more than 1.6:1, more preferably no more than 1.4:1 and most preferably no more than 1.2:1.

57. A particulate material according to any one of claims 31 to 56, having a BET surface area of less than 300 m²/g, preferably less than 250 m²/g, more preferably less than 200 m²/g, more preferably less than 150 m²/g, more preferably less than 120 m²/g.

58. A particulate material according to any one of claims 31 to 57, having a BET surface area of at least 10 m²/g, at least 11 m²/, at least 12 m²/g, at least 15 m²/g, at least 20 m²/g, or at least 50 m²/g.

59. A composition comprising a particulate material as defined in any one of claims 31 to 58 and at least one other component.

60. A composition according to claim 59, which is an electrode composition comprising a particulate material as defined in any one of claims 31 to 56, and at least one other component selected from: (i) a binder; (ii) a conductive additive; and (iii) an additional particulate electroactive material.

61. An electrode composition according to claim 60, comprising at least one additional particulate electroactive material.

62. An electrode composition according to claim 61, wherein the at least one additional particulate electroactive material is selected from graphite, hard carbon, gallium, aluminium and lead.

63. An electrode composition according to claim 62, wherein the at least one additional particulate electroactive material is graphite.

64. An electrode composition according to any one of claims 60 to 63, comprising a binder, preferably in an amount of from 0.5 to 20 wt %, more preferably 1 to 15 wt % and most preferably 2 to 10 wt %, based on the total weight of the electrode composition.

65. An electrode composition according to any one of claims 60 to 64, comprising one or more conductive additives, preferably in a total amount of from 0.5 to 20 wt %, more preferably 1 to 15 wt % and most preferably 2 to 10 wt %, based on the total weight of the electrode composition.

66. An electrode comprising a particulate material as defined in any one of claims 31 to 58 in electrical contact with a current collector.

67. An electrode according to claim 66, wherein the particulate material is in the form of an electrode composition as defined in any one of claims 60 to 65.

68. A rechargeable metal-ion battery comprising: (i) an anode, wherein the anode comprises an electrode as described in claim 66 or claim 67; (ii) a cathode comprising a cathode active material capable of releasing and reabsorbing metal ions; and (iii) an electrolyte between the anode and the cathode.

69. Use of a particulate material as defined in any one of claims 31 to 58 as an anode active material.

70. Use according to claim 69, wherein the particulate material is in the form of an electrode composition as defined in any one of claims 60 to 65.
